(19) United States
(12) Patent Application Publication
(10) Pub. No.: US 2025/0202563 A1
(43) Pub. Date: Jun. 19, 2025

(54) CONTROLLING A RECONFIGURABLE INTELLIGENT SURFACE USING A WEIGHTING MATRIX

(71) Applicant: QUALCOMM Incorporated, San Diego, CA (US)

(72) Inventors: Ahmed ELSHAFIE, San Diego, CA (US); Yu ZHANG, San Diego, CA (US); Seyedkianoush HOSSEINI, San Diego, CA (US)

(21) Appl. No.: 18/842,206

(22) PCT Filed: Apr. 11, 2022
(86) PCT No.: PCT/CN2022/086064

§ 371 Date: Aug. 28, 2024

(51) Int. Cl. H04B 7/06; H04B 7/04; H04W 72/11

(52) U.S. Cl. CPC H04B 7/0695; H04B 7/04013; H04W 72/11

(57) ABSTRACT

Methods, systems, and devices for wireless communications are described. A network entity may transmit a set of resources allocated to a user equipment (UE) to the UE via a reconfigurable intelligent surface (RIS). The network entity may transmit an indication of a weighting matrix for controlling reflective elements of the RIS during transmission occasions. The RIS controller may apply different portions of the weighting matrix to the reflective elements for the transmission occasions. The network entity may transmit one or more transmission configuration indicator (TCI) states to the UE for each portion of the weighting matrix. The network entity and UE may communicate based on cyclically applying the different TCI states.

### CROSS REFERENCE

The present Application is a 371 national phase filing of International PCT Application No. PCT/CN2022/086064 by ELSHAFIE et al., entitled “CONTROLLING A RECONFIGURABLE INTELLIGENT SURFACE USING A WEIGHTING MATRIX,” filed Apr. 11, 2022, which is assigned to the assignee hereof, and which is expressly incorporated by reference in its entirety herein.

### TECHNICAL FIELD

The following relates to wireless communications, including controlling a reconfigurable intelligent surface (RIS) using a weighting matrix.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support controlling a reconfigurable intelligent surface (RIS) using a weighting matrix. For example, the described techniques provide for a network entity to configure a RIS controller to apply different portions of a weighting matrix during transmission occasions. The network entity, which may be a base station, may transmit resource allocated to a user equipment (UE) in a semi-persistent scheduling (SPS) message or configured grant to a RIS controller, and the RIS controller may reflect, or transmit, the resource allocation to the UE. In some cases, the network entity may transmit a weighting matrix for controlling one or more reflective elements of the RIS over transmission occasions. For example, the RIS controller may apply different portions of the weighting matrix to the reflective elements during transmission occasions. The network entity may send one or more transmission configuration indicator (TCI) states to the UE via the RIS for beamforming in accordance with the weighting matrix applied at the RIS. The UE and the network entity may communicate via the RIS by applying different TCI states as the RIS controller applies the different portions of the weighting matrix.

A method for wireless communication at a network entity is described. The method may include receiving an indication of a set of resources allocated to a UE according to a SPS or a configured grant, receiving an indication of a weighting matrix for a RIS, the weighting matrix corresponding to a set of multiple transmission occasions in the set of resources allocated to the UE, and applying different portions of the weighting matrix to a set of reflective elements of the RIS for the set of multiple transmission occasions.

An apparatus for wireless communication at a network entity is described. The apparatus may include a processor, memory coupled with the processor, and instructions stored in the memory. The instructions may be executable by the processor to cause the network entity to receive an indication of a set of resources allocated to a UE according to a SPS or a configured grant, receive an indication of a weighting matrix for a RIS, the weighting matrix corresponding to a set of multiple transmission occasions in the set of resources allocated to the UE, and apply different portions of the weighting matrix to a set of reflective elements of the RIS for the set of multiple transmission occasions.

Another apparatus for wireless communication at a network entity is described. The apparatus may include means for receiving an indication of a set of resources allocated to a UE according to a SPS or a configured grant, means for receiving an indication of a weighting matrix for a RIS, the weighting matrix corresponding to a set of multiple transmission occasions in the set of resources allocated to the UE, and means for applying different portions of the weighting matrix to a set of reflective elements of the RIS for the set of multiple transmission occasions.

A non-transitory computer-readable medium storing code for wireless communication at a network entity is described. The code may include instructions executable by a processor to receive an indication of a set of resources allocated to a UE according to a SPS or a configured grant, receive an indication of a weighting matrix for a RIS, the weighting matrix corresponding to a set of multiple transmission occasions in the set of resources allocated to the UE, and apply different portions of the weighting matrix to a set of reflective elements of the RIS for the set of multiple transmission occasions.

In some examples of the method, apparatuses, and non-transitory computer-readable medium described herein, applying the different portions of the weighting matrix may include operations, features, means, or instructions for receiving first signaling indicating a periodicity of transmission occasions for applying the different portions of the weighting matrix and applying the weighting matrix to the set of reflective elements according to the periodicity of transmission occasions.

Some examples of the method, apparatuses, and non-transitory computer-readable medium described herein may further include operations, features, means, or instructions for receiving second signaling indicating an updated periodicity of transmission occasions for applying the different portions of the weighting matrix, where the second signaling includes downlink control information (DCI) signaling.

In some examples of the method, apparatuses, and non-transitory computer-readable medium described herein, a size of the DCI signaling corresponds to a number of different portions of the weighting matrix.

Some examples of the method, apparatuses, and non-transitory computer-readable medium described herein may further include operations, features, means, or instructions for receiving an indication of a TCI state for at least one transmission occasion of the set of multiple transmission occasions, the TCI state associated with the weighting matrix.

Some examples of the method, apparatuses, and non-transitory computer-readable medium described herein may further include operations, features, means, or instructions for receiving a priority indicator for the set of resources and determining a communication resolution for the set of multiple transmission occasions in accordance with the priority indicator.

Some examples of the method, apparatuses, and non-transitory computer-readable medium described herein may further include operations, features, means, or instructions for transmitting a feedback message, where receiving the indication of the weighting matrix may be based on transmitting the feedback message.

Some examples of the method, apparatuses, and non-transitory computer-readable medium described herein may further include operations, features, means, or instructions for apply zero value weights of the weighting matrix to the set of reflective elements of the RIS based on transmitting a negative acknowledgement (NACK) message, where the feedback message includes the NACK message and the indication of the weighting matrix includes the zero value weights.

Some examples of the method, apparatuses, and non-transitory computer-readable medium described herein may further include operations, features, means, or instructions for apply a default TCI for the set of multiple transmission occasions based on transmitting a NACK message, where the feedback message includes the NACK message.

In some examples of the method, apparatuses, and non-transitory computer-readable medium described herein, the default TCI may be configured at the RIS based on a frequency band of operation, a component carrier, a zone identifier, a position of the UE, or any combination thereof.

In some examples of the method, apparatuses, and non-transitory computer-readable medium described herein, the default TCI may be a last known TCI based on a zone identifier, a position of the UE, previous communications with the UE, or any combination thereof.

Some examples of the method, apparatuses, and non-transitory computer-readable medium described herein may further include operations, features, means, or instructions for receiving the indication of the weighting matrix in multiple stages of control information including a first stage of control information common to the RIS and the UE and a second stage of control information specific to the RIS.

Some examples of the method, apparatuses, and non-transitory computer-readable medium described herein may further include operations, features, means, or instructions for receiving control information including the indication of the weighting matrix, where a size of the control information may be based on a maximum number of transmission occasions in the set of multiple transmission occasions.

Some examples of the method, apparatuses, and non-transitory computer-readable medium described herein may further include operations, features, means, or instructions for receiving an indication of one or more TCI indices for the set of multiple transmission occasions, where the applying the different portions of the weighting matrix to the set of reflective elements of the RIS may be in accordance with the one or more TCI indices.

Some examples of the method, apparatuses, and non-transitory computer-readable medium described herein may further include operations, features, means, or instructions for receiving the indication of the set of resources allocated to the UE according to the configured grant, where radio resource control (RRC) signaling or a medium access control-control element (MAC-CE) include the indication of the set of resources and the indication of the weighting matrix.

A method for wireless communication at a UE is described. The method may include receiving an indication of a set of resources allocated to the UE according to a SPS or a configured grant, receiving an indication of a set of multiple TCI states corresponding to a weighting matrix for a RIS, the set of multiple TCI states corresponding to a set of multiple transmission occasions in the set of resources allocated to the UE, and applying different TCI states of the plurality of TCI states to the plurality of transmission occasions to communicate with a network entity over the set of resources via the RIS.

An apparatus for wireless communication at a UE is described. The apparatus may include a processor, memory coupled with the processor, and instructions stored in the memory. The instructions may be executable by the processor to cause the UE to receive an indication of a set of resources allocated to the UE according to a SPS or a configured grant, receive an indication of a set of multiple TCI states corresponding to a weighting matrix for a RIS, the set of multiple TCI states corresponding to a set of multiple transmission occasions in the set of resources allocated to the UE, and applying different TCI states of the plurality of TCI states to the plurality of transmission occasions to communicate with a network entity over the set of resources via the RIS.

Another apparatus for wireless communication at a UE is described. The apparatus may include means for receiving an indication of a set of resources allocated to the UE according to a SPS or a configured grant, means for receiving an indication of a set of multiple TCI states corresponding to a weighting matrix for a RIS, the set of multiple TCI states corresponding to a set of multiple transmission occasions in the set of resources allocated to the UE, and means for applying different TCI states of the plurality of TCI states to the plurality of transmission occasions to communicate with a network entity over the set of resources via the RIS.

A non-transitory computer-readable medium storing code for wireless communication at a UE is described. The code may include instructions executable by a processor to receive an indication of a set of resources allocated to the UE according to a SPS or a configured grant, receive an indication of a set of multiple TCI states corresponding to a weighting matrix for a RIS, the set of multiple TCI states corresponding to a set of multiple transmission occasions in the set of resources allocated to the UE, and apply different TCI states of the plurality of TCI states to the plurality of transmission occasions to communicate with a network entity over the set of resources via the RIS.

In some examples of the method, apparatuses, and non-transitory computer-readable medium described herein may further include operations, features, means, or instructions for transmitting signaling over the set of resources via the RIS.

In some examples of the method, apparatuses, and non-transitory computer-readable medium described herein may further include operations, features, means, or instructions for receiving signaling over the set of resources via the RIS.

In some examples of the method, apparatuses, and non-transitory computer-readable medium described herein, the network entity includes another UE and the method, apparatuses, and non-transitory computer-readable medium may include further operations, features, means, or instructions for receiving the indication of the set of multiple TCI states corresponding to the weighting matrix in sidelink control information.

Some examples of the method, apparatuses, and non-transitory computer-readable medium described herein may further include operations, features, means, or instructions for receiving the indication of the set of resources allocated to the UE according to the configured grant, where RRC signaling or a MAC-CE include the indication of the set of resources and the indication of the weighting matrix.

Some examples of the method, apparatuses, and non-transitory computer-readable medium described herein may further include operations, features, means, or instructions for receiving the indication of the set of multiple TCI states corresponding to the weighting matrix in a stage of control information common to the RIS and the UE.

A method for wireless communication at a network entity is described. The method may include transmitting an indication of a set of resources allocated to a UE according to a SPS or a configured grant, transmitting an indication of a set of multiple TCI states corresponding to a weighting matrix for a RIS, the set of multiple TCI states corresponding to a set of multiple transmission occasions in the set of resources allocated to the UE, and communicating with the UE over the set of resources via the RIS, where the communicating is based on the set of multiple TCI states.

An apparatus for wireless communication at a network entity is described. The apparatus may include a processor, memory coupled with the processor, and instructions stored in the memory. The instructions may be executable by the processor to cause the network entity to transmit an indication of a set of resources allocated to a UE according to a SPS or a configured grant, transmit an indication of a set of multiple TCI states corresponding to a weighting matrix for a RIS, the set of multiple TCI states corresponding to a set of multiple transmission occasions in the set of resources allocated to the UE, and communicate with the UE over the set of resources via the RIS, where the communicating is based on the set of multiple TCI states.

Another apparatus for wireless communication at a network entity is described. The apparatus may include means for transmitting an indication of a set of resources allocated to a UE according to a SPS or a configured grant, means for transmitting an indication of a set of multiple TCI states corresponding to a weighting matrix for a RIS, the set of multiple TCI states corresponding to a set of multiple transmission occasions in the set of resources allocated to the UE, and means for communicating with the UE over the set of resources via the RIS, where the communicating is based on the set of multiple TCI states.

A non-transitory computer-readable medium storing code for wireless communication at a network entity is described. The code may include instructions executable by a processor to transmit an indication of a set of resources allocated to a UE according to a SPS or a configured grant, transmit an indication of a set of multiple TCI states corresponding to a weighting matrix for a RIS, the set of multiple TCI states corresponding to a set of multiple transmission occasions in the set of resources allocated to the UE, and communicate with the UE over the set of resources via the RIS, where the communicating is based on the set of multiple TCI states.

Some examples of the method, apparatuses, and non-transitory computer-readable medium described herein may further include operations, features, means, or instructions for transmitting first signaling indicating a periodicity of transmission occasions for applying one or more different portions of the weighting matrix to a set of reflective elements of the RIS for the set of multiple transmission occasions.

Some examples of the method, apparatuses, and non-transitory computer-readable medium described herein may further include operations, features, means, or instructions for transmitting second signaling indicating an updated periodicity of transmission occasions for applying the different portions of the weighting matrix, where the second signaling includes DCI signaling.

In some examples of the method, apparatuses, and non-transitory computer-readable medium described herein, a size of the DCI signaling corresponds to a number of different portions of the weighting matrix.

Some examples of the method, apparatuses, and non-transitory computer-readable medium described herein may further include operations, features, means, or instructions for transmitting a priority indicator for the set of resources.

Some examples of the method, apparatuses, and non-transitory computer-readable medium described herein may further include operations, features, means, or instructions for receiving a feedback message, where transmitting the indication of the set of multiple TCI states corresponding to the weighting matrix may be based on receiving the feedback message.

In some examples of the method, apparatuses, and non-transitory computer-readable medium described herein, the weighting matrix includes zero value weights based on the feedback message being a NACK message.

Some examples of the method, apparatuses, and non-transitory computer-readable medium described herein may further include operations, features, means, or instructions for transmitting the indication of the set of multiple TCI states corresponding to the weighting matrix in multiple stages of control information including a first stage of control information common to the RIS and the UE and a second stage of control information specific to the RIS.

Some examples of the method, apparatuses, and non-transitory computer-readable medium described herein may further include operations, features, means, or instructions for transmitting control information including an indication of the weighting matrix, where a size of the control information may be based on a maximum number of transmission occasions in the set of multiple transmission occasions.

Some examples of the method, apparatuses, and non-transitory computer-readable medium described herein may further include operations, features, means, or instructions for transmitting the indication of the set of resources allocated to the UE according to the configured grant, where RRC signaling or a MAC-CE include the indication of the set of resources and the indication of the weighting matrix.

In some examples of the method, apparatuses, and non-transitory computer-readable medium described herein, the communicating with the UE may include operations, features, means, or instructions for transmitting signaling over the set of resources via the RIS.

In some examples of the method, apparatuses, and non-transitory computer-readable medium described herein, the communicating with the UE may include operations, features, means, or instructions for receiving signaling over the set of resources via the RIS.

### BRIEF DESCRIPTION OF THE DRAWINGS

FIGS. 1 and 2 illustrates an example of a wireless communications system that supports controlling a reconfigurable intelligent surface (RIS) using a weighting matrix in accordance with one or more aspects of the present disclosure.

FIG. 3 illustrates an example of a transmission diagram that supports controlling a RIS using a weighting matrix in accordance with one or more aspects of the present disclosure.

FIG. 4 illustrates an example of a process flow that supports controlling a RIS using a weighting matrix in accordance with one or more aspects of the present disclosure.

FIGS. 5 and 6 show block diagrams of devices that support controlling a RIS using a weighting matrix in accordance with one or more aspects of the present disclosure.

FIG. 7 shows a block diagram of a communications manager that supports controlling a RIS using a weighting matrix in accordance with one or more aspects of the present disclosure.

FIG. 8 shows a diagram of a system including a device that supports controlling a RIS using a weighting matrix in accordance with one or more aspects of the present disclosure.

FIGS. 9 and 10 show block diagrams of devices that support controlling a RIS using a weighting matrix in accordance with one or more aspects of the present disclosure.

FIG. 11 shows a block diagram of a communications manager that supports controlling a RIS using a weighting matrix in accordance with one or more aspects of the present disclosure.

FIG. 12 shows a diagram of a system including a device that supports controlling a RIS using a weighting matrix in accordance with one or more aspects of the present disclosure.

FIGS. 13 through 19 show flowcharts illustrating methods that support controlling a RIS using a weighting matrix in accordance with one or more aspects of the present disclosure.

### DETAILED DESCRIPTION

Some wireless communications systems may implement one or more reconfigurable intelligent surfaces (RISs) to reflect signaling to extend coverage for a network entity. The RIS may use one or more movable reflective elements to reflect a radio wave in a desired direction, which may be configured by a network entity. The network entity may dynamically schedule communications for user equipments (UEs) using semi-persistent scheduling (SPS), a configured grant, or both. For example, the network entity may transmit control signaling (e.g., downlink control information (DCI) signaling) indicating resources allocated for communications between the network entity and the UE. In some cases, a transmit beam (e.g., time-frequency resources and direction of reflection) for the RIS may change with time as well as frequency allocation for downlink and uplink communications between the UE and the network entity. However, the RIS may not receive the control signaling indicating the resource allocated for the communications between the network entity and the UE.

In some examples, a RIS controller may implement a weighting matrix (e.g., beamforming matrix) for controlling reflective elements for communications between a network entity and a UE. A network entity may transmit an indication of a set of resources allocated to a UE in SPS, a configured grant, or both to a RIS controller and the UE. The RIS controller may receive the indication as well as reflect the indication to the UE. In some cases, the RIS controller may receive control signaling (e.g., DCI) indicating the weighting matrix for transmission occasions in the resources allocated to the UE. The RIS controller may cyclically apply different portions of the weighting matrix to reflective elements of the RIS. For example, the network entity may configure, or reconfigure, a periodicity of transmission occasions for applying the different portions in DCI. The network entity may transmit an indication of transmission configuration indicator (TCI) states to the UE, such that the UE may communicate with the network entity by applying different TCI states to the transmission occasions. The weighting matrix may align with the TCI states (e.g., for beam alignment between the UE, RIS, and network entity).

Aspects of the disclosure are initially described in the context of wireless communications systems. Aspects of the disclosure are further described in the context of transmission diagrams and process flows. Aspects of the disclosure are further illustrated by and described with reference to apparatus diagrams, system diagrams, and flowcharts that relate to controlling a RIS using a weighting matrix.

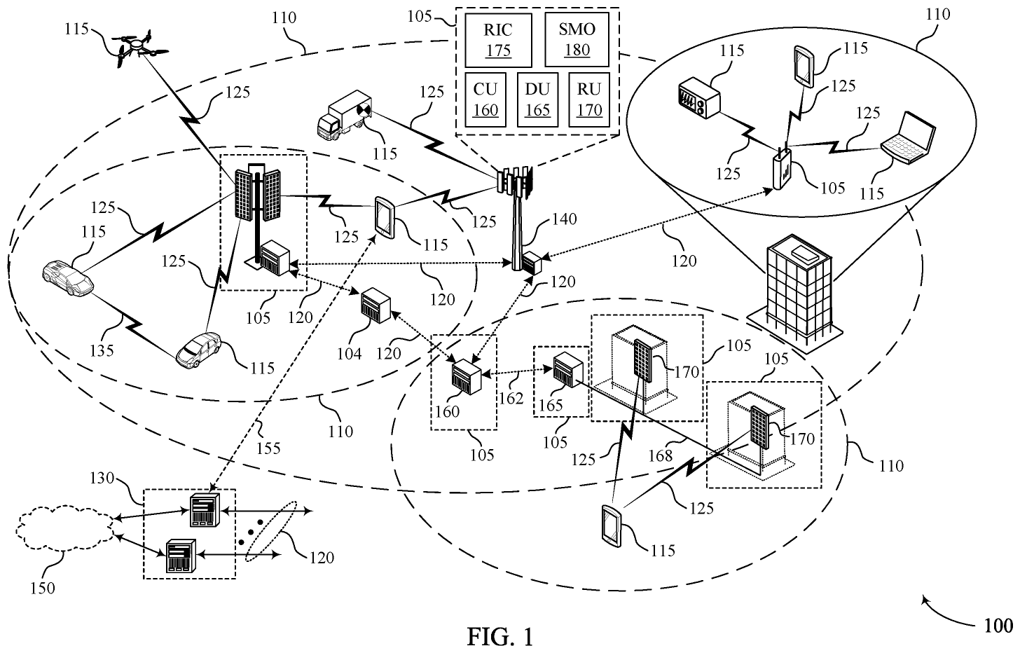

FIG. 1 illustrates an example of a wireless communications system 100 that supports controlling a RIS using a weighting matrix in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support controlling a RIS using a weighting matrix as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, wireless communications system 100 may include one or more RISs to reflect signaling to extend coverage for a network entity 105, a controlling UE 115, or both. The RIS may use one or more reflective elements to reflect a radio wave in a desired direction, which may be configured by a network entity 105. The network entity 105 may schedule communications for UEs periodically, dynamically, or both. For example, the network entity 105 may use SPS, a configured grant, or both to schedule data or control information transmissions and receptions. The network entity 105 may transmit control signaling (e.g., DCI signaling, RRC signaling, a medium access control-control element (MAC-CE), or any combination thereof) indicating resources allocated for communications between the network entity 105 and the UE 115. In some cases, a transmit beam (e.g., time-frequency resources and direction of reflection) for the RIS may change with time as well as frequency allocation for downlink and uplink communications between the UE 115 and the network entity 105. However, the RIS may not receive the control signaling indicating the resource allocated for the communications between the network entity 105 and the UE 115.

In some examples, a RIS controller may implement a weighting matrix (e.g., beamforming matrix) for controlling reflective elements for communications between a network entity 105 and a UE 115. A network entity 105 may transmit an indication of a set of resources allocated to a UE 115 in SPS, a configured grant, or both to a RIS controller and the UE 115. The RIS controller may receive the indication as well as reflect the indication to the UE 115. In some cases, the RIS controller may receive control signaling (e.g., DCI) indicating the weighting matrix for transmission occasions in the resources allocated to the UE 115. The RIS controller may cyclically apply different portions of the weighting matrix to reflective elements of the RIS. For example, the network entity 105 may configure, or reconfigure, a periodicity of transmission occasions for applying the different portions in DCI. The network entity 105 may transmit an indication of TCI states to the UE 115, such that the UE 115 may communicate with the network entity 105 or a controlling UE in sidelink by applying different TCI states to the transmission occasions. The weighting matrix may align with the TCI states (e.g., for beam alignment between the UE 115, RIS, and network entity 105).

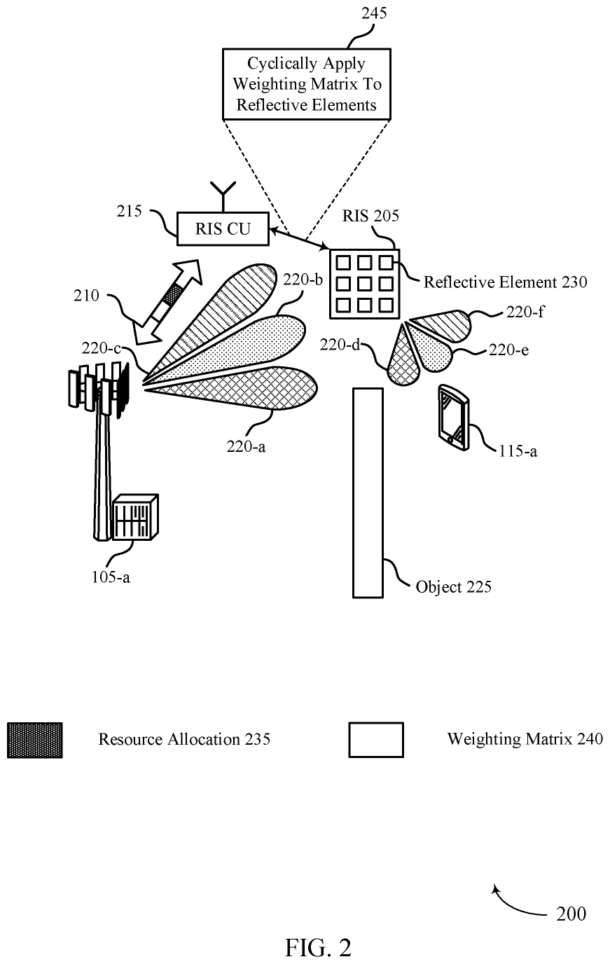

FIG. 2 illustrates an example of a wireless communications system 200 that supports controlling a RIS using a weighting matrix in accordance with one or more aspects of the present disclosure. The wireless communications system 200 may implement or be implemented to realize aspects of the wireless communications system 100. For example, the wireless communications system 200 illustrates communication between a UE 115-a and a network entity 105-a, which may be examples of corresponding devices described herein, including with reference to FIG. 1. In some cases, the UE 115-a and the network entity 105-a may establish communications via a RIS 205 by configuring a reflection characteristic of the RIS 205 in accordance with a weighting matrix.

In some examples, the wireless communications system 200 may employ massive MIMO (e.g., 5G massive MIMO) to increase an achievable throughput between two communicating devices. For example, the wireless communications system 200 may achieve relatively high beamforming gain by using one or more active antenna units (AAU), individual radio frequency chains per antenna port, or the like. However, using AAUs to increase throughput may cause relatively high power consumption. Thus, the wireless communications system may implement one or more RISs 205 to extend coverage with negligible increase to power consumption.

In some cases, network entity 105-a may establish a communication link 210 for transmitting or receiving control signaling, data, or both to and from UE 115-a via the RIS 205, which may be a near passive device (e.g., may not have power amplifiers). In some cases, the network entity 105-a may be an example of a base station, as described with reference to FIG. 1. The network entity 105-a may be in communication with one or more other network entities, such as a controller of the RIS (e.g., a RIS CU 215). The RIS CU 215 may be referred to as a network entity, or any other controlling device, and may communicate with the network entity 105-a via the communication link 210.

In some cases, a network entity 105-a and a UE 115-a may attempt to establish a communication link 210 with each other using a beamforming technique and via an assisting device controlled by an assisting node. In some aspects, such an assisting device may include or be an example of a RIS 205 and such an assisting node may include or be an example of a RIS CU 215 or some other device capable of CU functionality (e.g., any device capable of wirelessly transmitting or receiving or capable of configuring or otherwise controlling one or more assisting devices). The RIS 205 may be a near-passive device capable of reflecting an impinging or incident wave to a desired location or in a desired direction.

As illustrated by the wireless communications system 200, a network entity 105-a may communicate with a UE 115-a by using a RIS 205 to reflect one or more beams, such as beam 220-a through beam 220-c, to a UE 115-a around an object 225. In some cases, the object 225 may block or otherwise inhibits a line-of-sight (LoS) link between the network entity 105-a and the UE 115-a. The beam reflections around the object 225 may result in beam 220-d through beam 220-f. A RIS CU 215 may configure a reflection characteristic of the RIS 205 to control the reflection direction from the RIS 205. For example, the RIS CU 215 may control one or more reflective elements 230 of the RIS 205 to create beam 220-d through beam 220-f from beam 220-a through beam 220-c, respectively. In some cases, the network entity 105-a may configure or control the RIS CU 215, such that the network entity 105-a may effectively configure or control the reflection direction of the RIS 205. For example, a network entity 105-a may transmit messaging to the RIS CU 215 indicating a configuration of the RIS 205 and the RIS CU 215 may configure the RIS 205 accordingly. In some aspects, a configuration of the RIS 205 may be for a receive beam, such as a directional beam or configuration for directional “reception” of signaling, and a reflected beam, such a directional beam or configuration for directional reflection of the signaling. Further, although described herein as a “receive” beam, a receive beam associated with a configuration of the RIS 205 may refer to reception as part of a reflecting (as opposed to, for example, as part of a decoding). In some examples, wireless communications system 200 may illustrate an example of transmissions from a network entity 105-a to a UE 115-a. In some other examples, the transmissions may be from the UE 115-a to the network entity 105-a, from a UE to UE 115-a, or any combination thereof.

A RIS 205 may function similarly to a mirror or other reflective surface in its ability to reflect incident beams or waves (such as light waves), but may differ in that a RIS 205 may include one or more components that may control how an incident beam or wave is reflected (such that an angle of incidence can be different than an angle of reflection). Additionally, or alternatively, the RIS 205 may control a shape of a reflected beam or wave, such as via energy focusing or energy nulling via constructive interference or destructive interference, respectively. For example, a RIS 205 may include a quantity of reflective elements 230 that each have a controllable delay, phase, or polarization, or any combination thereof. The RIS CU 215 may configure each of the reflective elements 230 to control how an incident beam or wave may be reflected or to control a shape of a reflected beam or wave. A RIS 205 may be an example of or may otherwise be referred to as a software-controlled metasurface, a configurable reflective surface, a reflective intelligent surface, or a configurable intelligent surface, and may sometimes be a metal surface (e.g., a copper surface) including a quantity of reflective elements 230. In some aspects, a RIS CU 215 may be coupled with a RIS 205 via hardware (such as via a fiber optic cable). In some other aspects, a RIS CU 215 may be non-co-located with a RIS 205 and may configure the RIS 205 via over-the-air signaling.

In some examples, a network entity 105-a may train a RIS 205 to select a beam, or time-frequency resources in a direction, using a sequence of training reference signals. For example, the network entity 105-a may use one or more reference signals across beam 220-a through beam 220-c to train the RIS 205. The RIS CU 215 may receive the reference signals and may select a beam to use for transmission across communication link 210 based on one or more reception parameters, such as a beam with a highest spectral efficiency, reference signal receive power (RSRP), reference signal receive quality (RSRQ), and signal-to-interference and noise ratio (SINR).

In some examples, a network entity 105-a may schedule one or more data or control signaling transmissions or receptions for a UE 115-a in a resource allocation 235. The resource allocation 235 may periodically or dynamically indicate one or more time-frequency resources for the UE 115-a to use for the transmission or reception of the data, control signaling, or both. For example, the resource allocation 235 may be an SPS configuration (e.g., an SPS physical downlink shared channel (PDSCH) configuration), which the network entity 105-a may transmit with a periodicity. The periodicity may define a time between two transmission occasions (e.g., SPS PDSCH occasions). The resource allocation 235 may indicate a parameter, K1, which may specify an uplink control channel (e.g., physical uplink control channel (PUCCH)) grant time in one or more time intervals to send a feedback message for the shared channel transmission or reception (e.g., a HARQ-acknowledgement (ACK) after receiving the PDSCH).

In some cases, the SPS configuration may RRC configure the SPS periodicity and one or more feedback resources for the feedback message. The network entity 105-a may transmit an SPS activation or reactivation downlink control information (DCI) message to the UE 115-a to indicate whether to use the SPS configuration. Similarly, the network entity 105-a may transmit an SPS release DCI message to release the one or more resources indicated by the SPS configuration. That is, the network entity 105-a may use the SPS activation or reactivation DCI message to activate a configured SPS. The network entity 105-a may indicate one or more transmission parameters in the activation DCI message. The transmission parameters may include a modulation and coding scheme (MCS) a resource block allocation, and one or more antenna ports of the SPS transmission. The network entity 105-a may use the SPS reactivation DCI message to change, or update, the one or more transmission parameters. The network entity 105-a may use the SPS release DCI message to deactivate a configured SPS.

In some examples, a UE 115-a may decode a downlink SPS DCI message to determine an SPS configuration index. The SPS configuration index may indicate a configuration from RRC signaling, which may include a priority and a periodicity of the SPS configuration. The UE 115-a may receive or activate the SPS configuration based on receiving the SPS DCI message. The SPS configuration may include a time domain resource allocation (TDRA) indicating one or more time resources for a downlink or uplink transmission and a frequency domain resource allocation (FDRA) indicating one or more frequency resources for the downlink or uplink transmission. For example, the TDRA may include an indication of a time offset between a DCI message and a first data transmission (e.g., a PDSCH transmission) and a time domain allocation. as well as frequency domain allocation are determined. Additionally, or alternatively, the UE 115-a may determine an uplink transmission time based on the SPS configuration as well as the time of a last symbol (e.g., unit of time, such as OFDM symbol) of the SPS configuration occasion.

In some examples, a beam used at a surface of the RIS 205 may change with time as well as frequency in the resource allocation 235, such as according to a bandwidth part (BWP) or resource block allocation. Similarly, the beam may change based on a communication direction (e.g., transmission, sidelink, or uplink). However, the RIS CU 215 may be unaware of the SPS configuration, and may not adjust beam usage accordingly.

Thus, a RIS CU 215 may receive the resource allocation 235 for UE 115-a via a communication link 210 with a network entity 105-a. The RIS CU 215 may decode the resource allocation 235, and may use the information for beamforming. In some examples, the network entity 105-a may transmit a weighting matrix 240 to the RIS CU 215. The RIS CU 215 may use the weighting matrix 240 by cyclically applying portions of the weighting matrix 240 for beamforming. For example, the network entity 105-a may transmit control signaling (e.g., a DCI message, RRC signaling, or a MAC-CE) including the resource allocation 235, the weighting matrix 240, or both. In some cases, the control signaling may be an activation DCI message, reactivation DCI message, or release DCI message. In some other cases, the control signaling may be a configured grant. The network entity 105-a may indicate the weighting matrix 240, which may also be referred to as a beamforming matrix, to a RIS CU 215 for RIS 205, such that the RIS CU 215 may use the weighting matrix periodically. For example, the RIS CU 215 may apply the weighting matrix for every K set of transmission occasions (e.g., PDSCH occasions), where K may be a number of transmission occasions defined by the network entity 105-a (e.g., configured in the control signaling per SPS configuration index). In some cases, the network entity 105-a may transmit an indication of K in the SPS DCI message.

The RIS CU 215 may control the reflective elements 230 to transmit the resource allocation 235 and any additional control signaling to the UE 115-a. Thus, the UE 115-a and the RIS CU 215 may receive the activation DCI message, reactivation DCI message, release DCI message, or any combination thereof. The RIS CU 215 may use the information in the resource allocation 235 and the weighting matrix 240 to determine a time-frequency location of a downlink shared channel, uplink timing, downlink timing, and beam selection based on recommendations from the network entity 105-a. In some examples, the control signaling carrying the resource allocation 235 and the weighting matrix 240 may be a group common DCI message (e.g., common to the RIS CU 215 and the UE 115-a) or a dedicated DCI message. The network entity 105-a may beamform the control signaling to UE 115-a and to the RIS CU 215.

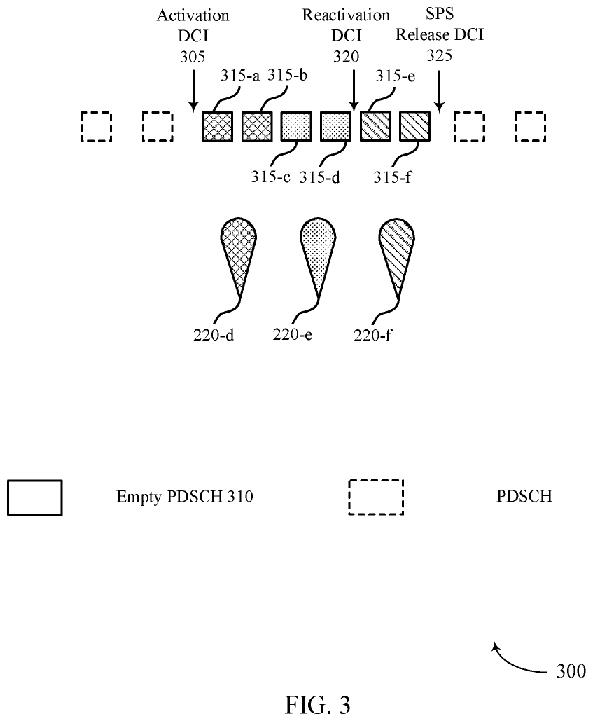

In some cases, the network entity 105-a may reconfigure K using an activation DCI message or reactivation DCI message. Thus, the size of the control signaling may depend on a value of K, since the network entity 105-a may provide beamforming information in the weighting matrix for each set of K. To align the size of the control information (e.g., DCI size), there may be a maximum size, or threshold value, of K. In some examples, when K is below the threshold value, the control signaling may be padded with zero bits (e.g., null values). For each K transmission occasions, the RIS CU 215 may apply a different portion of a beamforming matrix, or the weighting matrix 240, to form beam 220-d through beam 220-f, which is described in further detail with respect to FIG. 3.

In some examples, in addition to signaling a weighing matrix 245 for each K transmissions, the network entity 105-a (e.g., controlling the UE 115-a for sidelink communications) may transmit a set of beams to the RIS CU 215 for the RIS CU 215 to use for each uplink control channel (e.g., PUCCH) or sidelink feedback channel occasion (e.g., physical sidelink feedback channel (PSFCH)). The direction of the transmissions on the PUCCH and PSFCH (e.g., UE-to-UE transmissions) may be opposite in direction when compared with communications between the network entity 105-a and the UE 115-a.

In some examples, the weighting matrix 240 may include one or more diagonal matrices with a diagonal vector size equal to the number of reflective elements 230 of the RIS 205. A transmission window size, M, may be proportional to K. The network entity 105-a may include a number of beam indices in the weighting matrix 240 based on M (e.g., 4 beam indices if K is 2, because M=2×K for uplink and downlink). The UE 115-a may use same TCI states for same beam transmissions within the K transmission occasions. Thus, the UE 115-a and the network entity 105-a may use same spatial filtering matrices during the transmission of data across those occasions. The network entity 105-a may transmit an indication of TCI states for each set of transmission occasions based on the weighting matrix 240. For example, the network entity 105-a may transmit control signaling (e.g., a DCI message) to the UE 115-a via RIS 205, the control signaling indicating a TCI state for each transmission occasion or block of transmission occasions (e.g., for every K transmission occasions). The TCI states may be related to the weighting matrix 240 the RIS CU 215 applies to the reflective elements 230 of the RIS 205.

At 245, the RIS CU 215 may cyclically apply different portions of the weighting matrix 240 (e.g., for each K transmission occasions) to the set of reflective elements 230. For each portion of the weighting matrix 240, the reflective elements 230 may reflect a different beam, such as beam 220-d through beam 220-f, in accordance with the periodicity of the transmission occasions. For example, the RIS CU 215 may apply a first portion of the weighting matrix 240 to produce beam 220-d, a second portion of the weighting matrix 240 to produce beam 220-e, and a third portion of the weighting matrix 240 to produce beam 220-f, which is described in further detail with respect to FIG. 3. may The RIS CU 215 may control beam resolution by adjusting a number of reflective elements 230 used for the beamforming. For example, the RIS CU 215 may increase beam resolution with more reflective elements 230 or may reduce beam resolution with fewer reflective elements 230. In some cases, the beam resolution of a beam from the RIS 205 (e.g., beam 220-d through beam 220-f) may be a function of the SPS configuration priority, which may be configured by the network entity 105-a in RRC signaling. Based on a priority indicator and decoding a DCI message to determine an SPS configuration index, the RIS CU 215 may set up a beam resolution accordingly. In some cases, high priority transmissions (e.g., URLLC transmissions) may have relatively high beam resolution when compared with a lower priority transmission (e.g., an eMBB transmission).

In some cases, the RIS CU 215 may decode RRC signaling indicating the SPS configuration priority. In some other cases, the RIS CU 215 may be unable to decode the RRC signaling, so the network entity 105-a may include information from the RRC signaling in a DCI message. For example, an activation or reactivation DCI message may include priority information, a periodicity of SPS occasions, or both. Additionally, or alternatively, the network entity 105-a may transmit the information to the RIS CU 215 in a DCI stage dedicated for the RIS 205. Instead of using a single DCI, the network entity 105-a may configure one or more stages of DCI (e.g., two stage DCI). The stages may be divided into a common stage and a stage unique to the RIS 205. The network entity 105-a may signal the common stage to both the receiving UE 115-a and the RIS CU 215. The common stage may include a TRDA, frequency allocation (e.g., FDRA), time offsets for downlink and uplink transmissions, or any combination thereof. The network entity 105-a may use the RIS specific stage to handle additional information relevant to the RIS CU 215 (e.g., priority information for transmissions). In some cases, the initial stage of DCI may include search space information for any following stages of DCI.

To make the DCI message operation more robust, since the DCI may be decoded at the RIS CU 215 to determine timing and beam information for one or more transmission occasions, the RIS CU 215, the UE 115-a, or both may transmit a feedback message once the DCI message is decoded successfully (e.g., an ACK), if the DCI message is decoded unsuccessfully (e.g., a NACK), or both. In some cases, if the network entity 105-a receives a NACK from the RIS CU 215 for the DCI message the decoding may have failed at the RIS CU 215. The RIS CU 215 may turn off the surface of the RIS 205 by applying zero value weights in the weighting matrix 240 or may use a default beam. In some examples, the default beam may be configured by control signaling (e.g., RRC signaling or a MAC-CE) from a network entity 105-a, controlling UE, or other transmitting entity. The default beam may be based on a frequency band of operation, a component carrier used, a zone identifier (ID), a UE position, or any combination thereof. In some other examples, if the RIS CU 215 knows which UE or group of UEs are being served, the RIS CU 215 may use a last known beam as the default beam. The last known beam may be based on a zone ID, a position of a UE, previous communication with a UE (e.g., an averaged beam across many previous communications between a transmitter and receiver via a RIS 205), or any combination thereof. Thus, the default beam may be a function of UE position and zone ID.

In some examples, the network entity 105-a may include the resource allocation 235 and weighting matrix 240 in a configured grant, which may be a type 2 configured grant or a type 1 configured grant. For a type 1 configured grant, the network entity 105-a may include the resource allocation 235 and weighting matrix 240 in RRC signaling or a MAC-CE. In some cases, a controlling sidelink UE may transmit the resource allocation 235, the weighting matrix 240, or both (e.g., rather than a base station). For example, in a first sidelink operation mode (e.g., mode 1 transmission), where instead of a base station, or network entity 105-a, a UE handles the communication with the RIS CU 215 to send relayed data to another UE, such as UE 115-a. For sidelink communications, the controlling UE may transmit the RIS information, such as the weighting matrix 240 and resource allocation 235, in sidelink control information (SCI), such as in a first stage SCI or a new, dedicated SCI. In some cases, there may be a gap after the controlling UE transmits the SCI, so that the RIS CU 215 may adjust the reflective elements 230 to change the transmission beams or reception beams accordingly.

In some examples, the network entity 105-a or a controlling UE may transmit the SPS configuration, configured grant, or both to the RIS CU 215 to provide beamforming information for one or more transmission occasions or configured grants occasions. Once the RIS CU 215 detects the DCI or SCI carrying the resource allocation 235 and the weighting matrix 240, the RIS CU 215 may activate the SPS or configured grant during the configured grants times with the configured weighting matrix for beamforming. The network entity 105-a may transmit control signaling or data to UE 115-a via the RIS CU 215 while the RIS CU 215 applies the weighting matrix during transmission occasions. For example, the network entity 105-a may use beam 220-a to transmit data or control signaling, and the RIS CU 215 may reflect the data or control signaling using beam 220-d by applying a relevant portion of the weighting matrix. The UE 115-a may use a receive beam according to a TCI state for the relevant portion of the weighting matrix or transmission occasions, which may align (e.g., as a beam pair) with the beam 220-d. Similarly, the network entity 105-a may use beam 220-b and beam 220-c to transmit data or control signaling, and the RIS CU 215 may reflect the data or control signaling using beam 220-e and beam 220-f, respectively.

FIG. 3 illustrates an example of a transmission diagram 300 that supports controlling a RIS using a weighting matrix in accordance with one or more aspects of the present disclosure. In some examples, the transmission diagram 300 may implement aspects of wireless communications system 100 and wireless communications system 200. For example, the transmission diagram 300 may be implemented by a wireless communications system in which a RIS controller, such as a RIS CU, may cyclically apply a weighting matrix to reflective elements for communications between a network entity and UE or a UE and other UE, where the network entity, RIS controller, and UEs may be examples of the corresponding devices as described with reference to FIGS. 1 and 2.

In some examples, a network entity or controlling UE may use a RIS to increase a coverage area, transmission throughput, or both for communications with one or more wireless devices (e.g., UEs). The network entity or controlling UE may use one or more beams for the communications, which may define a set of time-frequency resources and transmission direction for communications. The communications may be sidelink communications, uplink communications, or downlink communications. In some examples, the network entity or controlling UE may transmit a weighting matrix to the RIS controller for beamforming. The RIS controller may use the weighting matrix in accordance with a periodicity to reflect one or more radio waves to another wireless device. In some examples, as described with reference to FIG. 2, the RIS controller may use different portions of the weighting matrix for different sets of transmission occasions to generate beams for each set of transmission occasions.

For example, as illustrated in transmission diagram 300, a network entity may transmit an activation DCI message 305 after one or more empty downlink shared channel transmission occasions (e.g., empty PDSCHs 310). The activation DCI message 305 may activate a SPS configuration for one or more periodic downlink shared channel transmissions, such as PDSCH 315-a and PDSCH 315-b, and PDSCH 315-c. The SPS configuration may specify a periodicity of transmission occasions, K, for which to apply a different portion of a weighting matrix. For example, the SPS configuration may indicate that K is two, and the RIS controller may apply a different portion of the weighting matrix for every two transmission occasions. In some cases, if K is two, the RIS controller may apply a first portion of the weighting matrix to reflect a PDSCH 315-a and PDSCH 315-b using beam 220-d, a second portion of the weighting matrix to reflect PDSCH 315-c and PDSCH 315-d using beam 220-e, and a third portion of the weighting matrix to reflect PDSCH 315-e and PDSCH 315-f using beam 220-f, where beam 220-d through beam 220-f may be an example of beam 220-d through beam 220-f as described with reference to FIG. 2.

In some examples, the network entity may transmit a reactivation DCI 320 after transmitting the activation DCI 305. The reactivation DCI 320 may update one or more communication parameters, as described with reference to FIG. 2. For example, the reactivation DCI 320 may update the value of K, or any other communication parameters. The RIS controller may continue to cyclically apply the weighting matrix until receiving an SPS release DCI 325. In some examples, rather than receiving DCI from a network entity, the RIS controller may receive SCI from a controlling UE. Similar to the DCI, the SCI may specify a value of K transmission occasions for which the RIS controller may apply different portions of the weighting matrix. Additionally, or alternatively, one or more PDSCH occasions with PDSCH 315-a through PDSCH 315-f may support uplink, sidelink, or downlink transmissions (e.g., a PUSCH, a physical sidelink shared channel (PSSCH), or both).

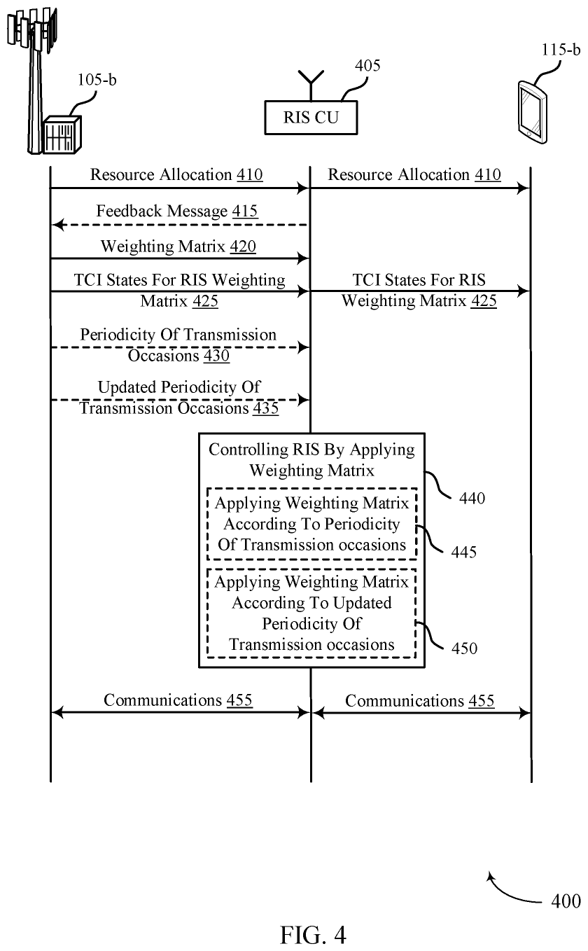

FIG. 4 illustrates an example of a process flow 400 that supports controlling a RIS using a weighting matrix in accordance with one or more aspects of the present disclosure. In some examples, the process flow 400 may implement aspects of wireless communications system 100, wireless communications system 200, and transmission diagram 300. The process flow 400 may illustrate an example of a network entity 105-b transmitting a resource allocation and weighting matrix to a RIS controller, such as RIS CU 405, where the RIS controller cyclically applies the weighting matrix to reflective elements of the RIS for beamforming. Network entity 105-b, UE 115-b, and RIS CU 405 may be examples of a network entity 105, a UE 115, and a RIS CU as described with reference to FIGS. 1 and 2. Alternative examples of the following may be implemented, where some processes are performed in a different order than described or are not performed. In some cases, processes may include additional features not mentioned below, or further processes may be added.

In some examples, the RIS CU 405 may be referred to as a network entity. The actions performed by the network entity 105-b may additionally, or alternatively, be performed by a controlling UE for sidelink communications.

At 410, network entity 105-b may transmit an indication of a set of resources allocated to UE 115-b to the RIS CU 405 and UE 115-b. In some cases, the RIS CU 405 may reflect the resource allocation to UE 115-b. In some other cases, the network entity 105-b may transmit the resource allocation directly to UE 115-b. The network entity 105-b may transmit the resource allocation in control signaling, such as one or more DCI messages, RRC signaling, a MAC-CE, or any combination thereof. The network entity 105-b perform an SPS transmission or a configured grant transmission carrying the resource allocation.

At 415, the RIS CU 405 may transmit a feedback message to the network entity 105-b based on receiving control signaling, which may include the resource allocation at 410. For example, the RIS CU 405 may transmit a positive feedback message (e.g., an ACK) if the resource allocation is received and decoded successfully, a negative feedback message (e.g., a NACK) if the resource allocation is received or decoded unsuccessfully, or both.

At 420, the network entity 105-b may transmit an indication of a weighting matrix, or beamforming matrix, to the RIS CU 405 for a RIS controlled by the RIS CU 405. The weighting matrix may be divided into portions, where each portion may be applied to a set of transmission occasions in the set of resources allocated to the UE 115-b. In some examples, the network entity 105-b may transmit the indication of the weighting matrix based on receiving an ACK from the RIS CU 405. In some other examples, the network entity 105-b may transmit a weighting matrix with zero value weights based on receiving a NACK from the RIS CU 405.

In some examples, the network entity 105-b may transmit the indication of the weighting matrix in multiple stages of control information, such as DCI. The stages may include a first stage of control information common to the RIS CU 405 and the UE 115-b and a second stage of control information specific to the RIS CU 405. In some cases, the network entity 105-b may transmit control information including the indication of the weighting matrix, where a size of the control information may be proportional to a maximum number of transmission occasions. The maximum number of transmission occasions may be configured (e.g., RRC configured) by the network entity 105-b.

At 425, the RIS CU 405 may relay, or reflect, an indication of TCI states to the UE 115-b from the network entity 105-b. Each TCI state may be for a different portion of the weighting matrix for the RIS. For example, each set of transmission occasions in the set of resources allocated to the UE 115-b may have a different TCI state. The RIS CU 405 may receive an indication of the TCI states from the network entity 105-b. In some examples, the RIS CU 405 may relay SCI including the TCI states to the UE 115-b from a controlling UE (e.g., rather than network entity 105-b).

At 430, the network entity 105-b may transmit control signaling (e.g., a DCI message, or SCI message in the case where the network entity 105-b is a controlling UE) indicating a periodicity, K, of transmission occasions for applying the different portions of the weighting matrix. For example, the network entity 105-b may transmit an activating DCI that activates an SPS configuration, or a configured grant DCI, that indicates the periodicity.

At 435, the network entity 105-b may transmit additional control signaling indicating an updated periodicity of transmission occasions. For example, the network entity 105-b may transmit a reactivation DCI for an SPS configuration that updates the value of K. A size of the DCI signaling may be proportional to a number of different portions of the weighting matrix. In some cases, the DCI may be divided into different stages of DCI, where a first stage is common to the RIS CU 405 and the UE 115-b and a second stage carries information for the RIS CU 405 and not the UE 115-b. The second stage may carry the control signaling indicating the periodicity and the updated periodicity.

At 440, the RIS CU 405 may control the RIS by cyclically applying different portions of the weighting matrix to a set of reflective elements of the RIS for the transmission occasions. For example, at 445, the RIS CU 405 may apply the weighting matrix to the set of reflective elements according to the periodicity of transmission occasions. In some other examples, at 450, the RIS CU 405 may apply the weighting matrix according to the updated periodicity of transmission occasions. In some cases, the RIS CU 405 may cyclically apply the different portions of the weighting matrix to the set of reflective elements of the RIS in accordance with the one or more TCI indices, such that there may be a beam pair (e.g., transmit and receive beam) at the UE 115-b and RIS CU 405.

In some examples, if the RIS CU 405 transmits a NACK at 415, the RIS CU 405 may apply zero value weights (e.g., null values) of the weighting matrix to the set of reflective elements. In some other examples, if the RIS CU 405 transmits a NACK at 415, the RIS CU 405 may apply a default TCI for the transmission occasions (e.g., a default beam). The default TCI may be configured at the RIS (e.g., RRC configured by the network entity 105-b) based on a frequency band of operation, a component carrier, a zone ID, a position of the UE, or any combination thereof. Additionally, or alternatively, the default TCI may be a last known TCI based on a zone ID, a position of the UE, previous communications with the UE, or any combination thereof.

In some examples, the RIS CU 405 may receive a priority indicator for the set of resources in control signaling (e.g., the control signaling carrying the periodicity of transmission occasions). The RIS CU 405 may determine a communication resolution for the transmission occasions based on the priority indicator. For example, if the priority of a transmission is relatively high, the RIS CU 405 may increase the communication resolution by using a greater number of reflective elements. Similarly, if the priority of the transmission is relatively low, the RIS CU 405 may decrease the communication resolution by using a fewer number of reflective elements. Reducing the communication resolution may improve power consumption at the RIS CU 405, among other benefits.

At 455, the network entity 105-b and the UE 115-b may communicate over the set of resources via the RIS. The communicating may be based on the network entity 105-b and UE 115-b cyclically applying different TCI states to the transmission occasions while the RIS CU 405 cyclically applies the weighting matrix to the transmission occasions. The communications may include the network entity 105-b transmitting data or control signaling to the UE 115-b, the network entity 105-b receiving data or control signaling from the UE 115-b, or the UE 115-b transmitting or receiving sidelink data or control information from another UE.

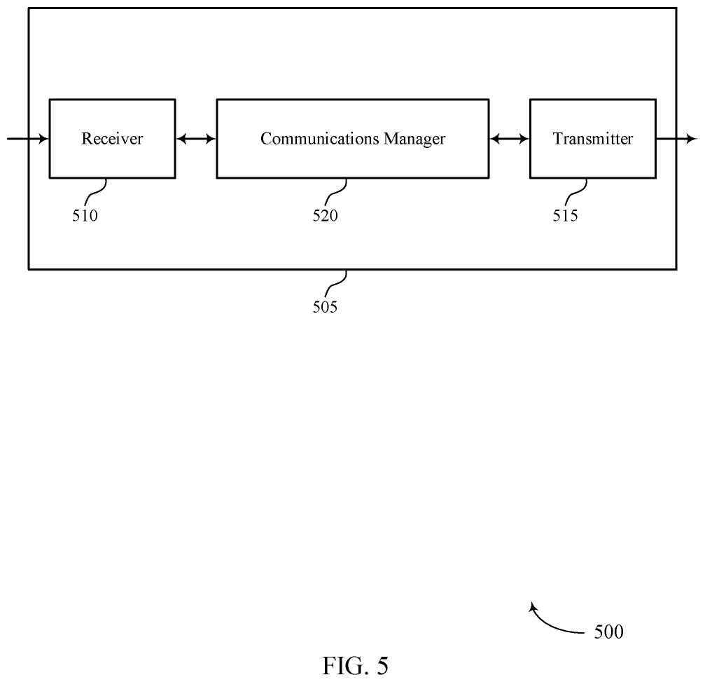

FIG. 5 shows a block diagram 500 of a device 505 that supports controlling a RIS using a weighting matrix in accordance with one or more aspects of the present disclosure. The device 505 may be an example of aspects of a network entity 105, such as a RIS controller, a RIS CU, or a base station, as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of controlling a RIS using a weighting matrix as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a network entity in accordance with examples as disclosed herein. For example, the communications manager 520 may be configured as or otherwise support a means for receiving an indication of a set of resources allocated to a UE according to a SPS or a configured grant. The communications manager 520 may be configured as or otherwise support a means for receiving an indication of a weighting matrix for a RIS, the weighting matrix corresponding to a set of multiple transmission occasions in the set of resources allocated to the UE. The communications manager 520 may be configured as or otherwise support a means for applying different portions of the weighting matrix to a set of reflective elements of the RIS for the set of multiple transmission occasions.

Additionally, or alternatively, the communications manager 520 may support wireless communication at a network entity in accordance with examples as disclosed herein. For example, the communications manager 520 may be configured as or otherwise support a means for transmitting an indication of a set of resources allocated to a UE according to a SPS or a configured grant. The communications manager 520 may be configured as or otherwise support a means for transmitting an indication of a set of multiple TCI states corresponding to a weighting matrix for a RIS, the set of multiple TCI states corresponding to a set of multiple transmission occasions in the set of resources allocated to the UE. The communications manager 520 may be configured as or otherwise support a means for communicating with the UE over the set of resources via the RIS, where the communicating is based on the set of multiple TCI states.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for a network entity to transmit a resource allocation and weighting matrix to a RIS controller, where the RIS controller cyclically applies the weighting matrix to reflective elements of the RIS for beamforming, which may provide for reduced processing, reduced power consumption, more efficient utilization of communication resources, or any combination thereof.

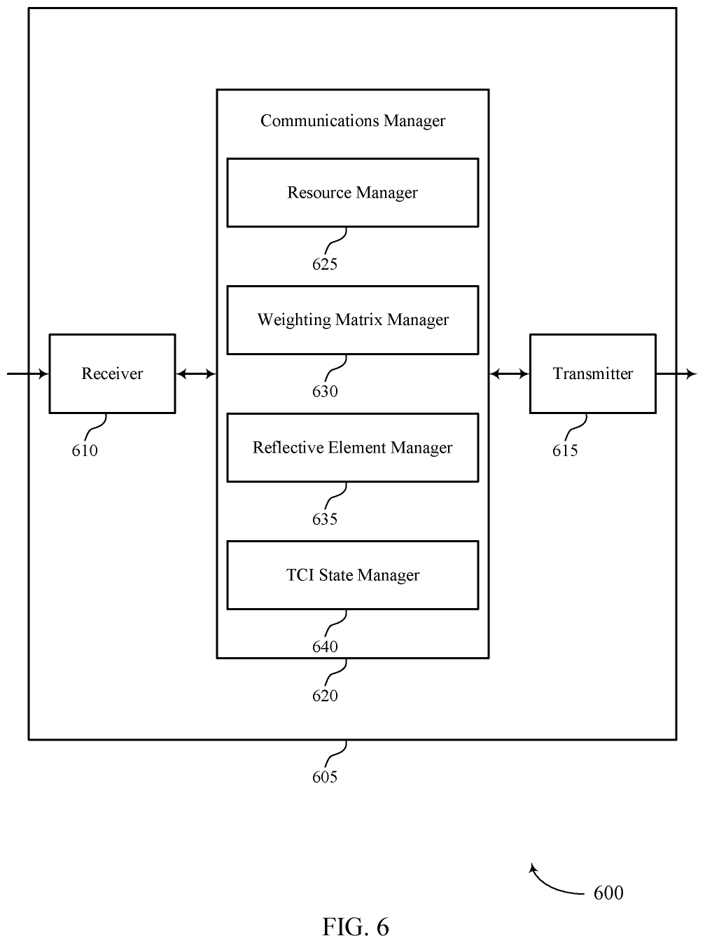

FIG. 6 shows a block diagram 600 of a device 605 that supports controlling a RIS using a weighting matrix in accordance with one or more aspects of the present disclosure. The device 605 may be an example of aspects of a device 505 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of controlling a RIS using a weighting matrix as described herein. For example, the communications manager 620 may include a resource manager 625, a weighting matrix manager 630, a reflective element manager 635, a TCI state manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a network entity in accordance with examples as disclosed herein. The resource manager 625 may be configured as or otherwise support a means for receiving an indication of a set of resources allocated to a UE according to a SPS or a configured grant. The weighting matrix manager 630 may be configured as or otherwise support a means for receiving an indication of a weighting matrix for a RIS, the weighting matrix corresponding to a set of multiple transmission occasions in the set of resources allocated to the UE. The reflective element manager 635 may be configured as or otherwise support a means for applying different portions of the weighting matrix to a set of reflective elements of the RIS for the set of multiple transmission occasions.

Additionally, or alternatively, the communications manager 620 may support wireless communication at a network entity in accordance with examples as disclosed herein. The resource manager 625 may be configured as or otherwise support a means for transmitting an indication of a set of resources allocated to a UE according to a SPS or a configured grant. The weighting matrix manager 630 may be configured as or otherwise support a means for transmitting an indication of a set of multiple TCI states corresponding to a weighting matrix for a RIS, the set of multiple TCI states corresponding to a set of multiple transmission occasions in the set of resources allocated to the UE. The TCI state manager 640 may be configured as or otherwise support a means for communicating with the UE over the set of resources via the RIS, where the communicating is based on the set of multiple TCI states.

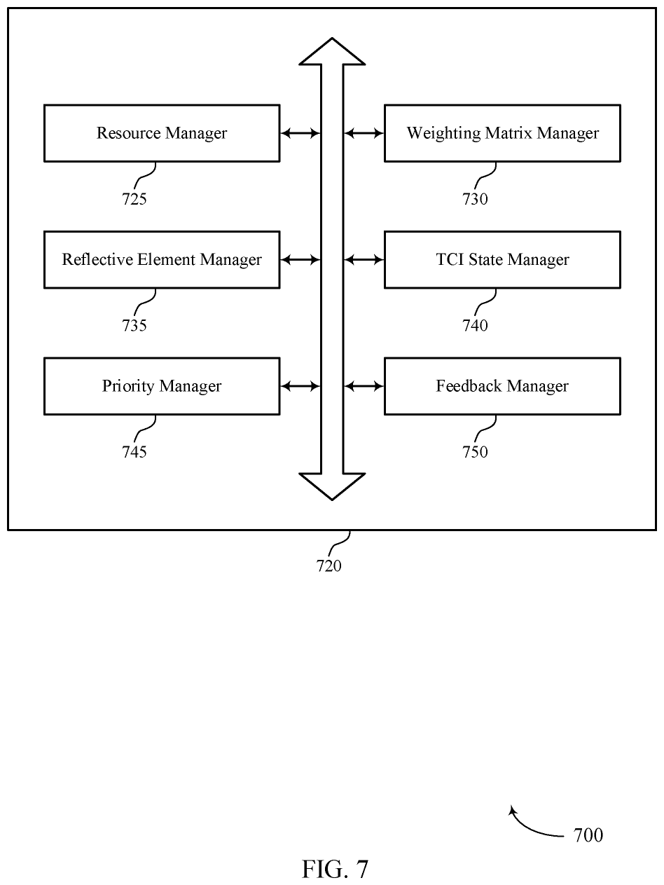

FIG. 7 shows a block diagram 700 of a communications manager 720 that supports controlling a RIS using a weighting matrix in accordance with one or more aspects of the present disclosure. The communications manager 720 may be an example of aspects of a communications manager 520, a communications manager 620, or both, as described herein. The communications manager 720, or various components thereof, may be an example of means for performing various aspects of controlling a RIS using a weighting matrix as described herein. For example, the communications manager 720 may include a resource manager 725, a weighting matrix manager 730, a reflective element manager 735, a TCI state manager 740, a priority manager 745, a feedback manager 750, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communication at a network entity in accordance with examples as disclosed herein. The resource manager 725 may be configured as or otherwise support a means for receiving an indication of a set of resources allocated to a UE according to a SPS or a configured grant. The weighting matrix manager 730 may be configured as or otherwise support a means for receiving an indication of a weighting matrix for a RIS, the weighting matrix corresponding to a set of multiple transmission occasions in the set of resources allocated to the UE. The reflective element manager 735 may be configured as or otherwise support a means for controlling the RIS based on cyclically applying different portions of the weighting matrix to a set of reflective elements of the RIS for the set of multiple transmission occasions.

In some examples, to support cyclically applying the different portions of the weighting matrix, the weighting matrix manager 730 may be configured as or otherwise support a means for receiving first signaling indicating a periodicity of transmission occasions for applying the different portions of the weighting matrix. In some examples, to support cyclically applying the different portions of the weighting matrix, the reflective element manager 735 may be configured as or otherwise support a means for applying the weighting matrix to the set of reflective elements according to the periodicity of transmission occasions.

In some examples, the weighting matrix manager 730 may be configured as or otherwise support a means for receiving second signaling indicating an updated periodicity of transmission occasions for applying the different portions of the weighting matrix, where the second signaling includes downlink control information signaling.

In some examples, a size of the downlink control information signaling corresponds to a number of different portions of the weighting matrix.

In some examples, the TCI state manager 740 may be configured as or otherwise support a means for receiving an indication of a TCI state for at least one transmission occasion of the set of multiple transmission occasions, the TCI state associated with the weighting matrix.

In some examples, the priority manager 745 may be configured as or otherwise support a means for receiving a priority indicator for the set of resources. In some examples, the priority manager 745 may be configured as or otherwise support a means for determining a communication resolution for the set of multiple transmission occasions in accordance with the priority indicator.

In some examples, the feedback manager 750 may be configured as or otherwise support a means for transmitting a feedback message, where receiving the indication of the weighting matrix is based on transmitting the feedback message.

In some examples, the reflective element manager 735 may be configured as or otherwise support a means for apply zero value weights of the weighting matrix to the set of reflective elements of the RIS based on transmitting a negative acknowledgement message, where the feedback message includes the negative acknowledgement message and the indication of the weighting matrix includes the zero value weights.

In some examples, the TCI state manager 740 may be configured as or otherwise support a means for apply a default TCI for the set of multiple transmission occasions based on transmitting a negative acknowledgement message, where the feedback message includes the negative acknowledgement message.

In some examples, the default TCI is configured at the RIS based on a frequency band of operation, a component carrier, a zone identifier, a position of the UE, or any combination thereof.

In some examples, the default TCI is a last known TCI based on a zone identifier, a position of the UE, previous communications with the UE, or any combination thereof.

In some examples, the weighting matrix manager 730 may be configured as or otherwise support a means for receiving the indication of the weighting matrix in multiple stages of control information including a first stage of control information common to the RIS and the UE and a second stage of control information specific to the RIS. In some examples, the weighting matrix manager 730 may be configured as or otherwise support a means for receiving control information including the indication of the weighting matrix, where a size of the control information is based on a maximum number of transmission occasions in the set of multiple transmission occasions.

In some examples, the TCI state manager 740 may be configured as or otherwise support a means for receiving an indication of one or more TCI indices for the set of multiple transmission occasions, where the applying the different portions of the weighting matrix to the set of reflective elements of the RIS is in accordance with the one or more TCI indices.

In some examples, the resource manager 725 may be configured as or otherwise support a means for receiving the indication of the set of resources allocated to the UE according to the configured grant, where radio resource control signaling or a medium access control-control element include the indication of the set of resources and the indication of the weighting matrix.

Additionally, or alternatively, the communications manager 720 may support wireless communication at a network entity in accordance with examples as disclosed herein. In some examples, the resource manager 725 may be configured as or otherwise support a means for transmitting an indication of a set of resources allocated to a UE according to a SPS or a configured grant. In some examples, the weighting matrix manager 730 may be configured as or otherwise support a means for transmitting an indication of a set of multiple TCI states corresponding to a weighting matrix for a RIS, the set of multiple TCI states corresponding to a set of multiple transmission occasions in the set of resources allocated to the UE. The TCI state manager 740 may be configured as or otherwise support a means for communicating with the UE over the set of resources via the RIS, where the communicating is based on the set of multiple TCI states.

In some examples, the reflective element manager 735 may be configured as or otherwise support a means for transmitting first signaling indicating a periodicity of transmission occasions for applying one or more different portions of the weighting matrix to a set of reflective elements of the RIS for the set of multiple transmission occasions.

In some examples, the reflective element manager 735 may be configured as or otherwise support a means for transmitting second signaling indicating an updated periodicity of transmission occasions for applying the different portions of the weighting matrix, where the second signaling includes downlink control information signaling.

In some examples, a size of the downlink control information signaling corresponds to a number of different portions of the weighting matrix.

In some examples, the priority manager 745 may be configured as or otherwise support a means for transmitting a priority indicator for the set of resources.

In some examples, the feedback manager 750 may be configured as or otherwise support a means for receiving a feedback message, where transmitting the indication of the set of multiple TCI states corresponding to the weighting matrix is based on receiving the feedback message.

In some examples, the weighting matrix includes zero value weights based on the feedback message being a negative acknowledgement message.

In some examples, the TCI state manager 740 may be configured as or otherwise support a means for transmitting the indication of the set of multiple TCI states corresponding to the weighting matrix in multiple stages of control information including a first stage of control information common to the RIS and the UE and a second stage of control information specific to the RIS.

In some examples, the weighting matrix manager 730 may be configured as or otherwise support a means for transmitting control information including an indication of the weighting matrix, where a size of the control information is based on a maximum number of transmission occasions in the set of multiple transmission occasions.

In some examples, the resource manager 725 may be configured as or otherwise support a means for transmitting the indication of the set of resources allocated to the UE according to the configured grant, where radio resource control signaling or a medium access control-control element include the indication of the set of resources and the indication of the weighting matrix.

In some examples, to support communicating with the UE, the TCI state manager 740 may be configured as or otherwise support a means for transmitting signaling over the set of resources via the RIS.

In some examples, to support communicating with the UE, the TCI state manager 740 may be configured as or otherwise support a means for receiving signaling over the set of resources via the RIS.

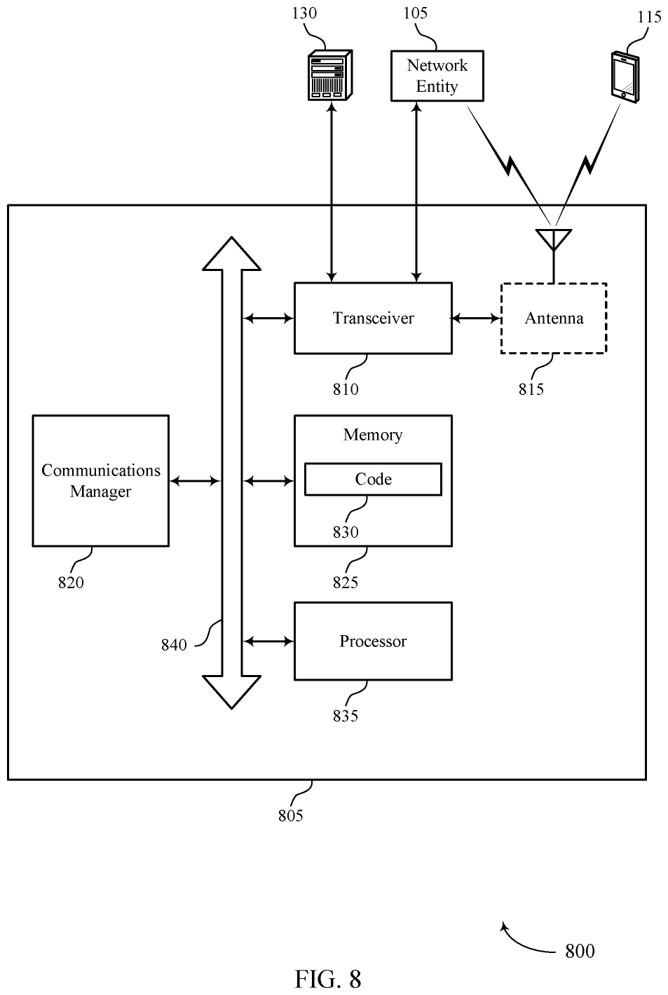

FIG. 8 shows a diagram of a system 800 including a device 805 that supports controlling a RIS using a weighting matrix in accordance with one or more aspects of the present disclosure. The device 805 may be an example of or include the components of a device 505, a device 605, or a network entity 105, such as a RIS controller, a RIS CU, or a base station, as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. The transceiver 810, or the transceiver 810 and one or more antennas 815 or wired interfaces, where applicable, may be an example of a transmitter 515, a transmitter 615, a receiver 510, a receiver 610, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting controlling a RIS using a weighting matrix). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communication at a network entity in accordance with examples as disclosed herein. For example, the communications manager 820 may be configured as or otherwise support a means for receiving an indication of a set of resources allocated to a UE according to a SPS or a configured grant. The communications manager 820 may be configured as or otherwise support a means for receiving an indication of a weighting matrix for a RIS, the weighting matrix corresponding to a set of multiple transmission occasions in the set of resources allocated to the UE. The communications manager 820 may be configured as or otherwise support a means for applying different portions of the weighting matrix to a set of reflective elements of the RIS for the set of multiple transmission occasions.

Additionally, or alternatively, the communications manager 820 may support wireless communication at a network entity in accordance with examples as disclosed herein. For example, the communications manager 820 may be configured as or otherwise support a means for transmitting an indication of a set of resources allocated to a UE according to a SPS or a configured grant. The communications manager 820 may be configured as or otherwise support a means for transmitting an indication of a set of multiple TCI states corresponding to a weighting matrix for a RIS, the set of multiple TCI states corresponding to a set of multiple transmission occasions in the set of resources allocated to the UE. The communications manager 820 may be configured as or otherwise support a means for communicating with the UE over the set of resources via the RIS, where the communicating is based on the set of multiple TCI states.

By including or configuring the communications manager 820 in accordance with examples as described herein, the device 805 may support techniques for a network entity to transmit a resource allocation and weighting matrix to a RIS controller, where the RIS controller cyclically applies the weighting matrix to reflective elements of the RIS for beamforming, which may provide for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the processor 835, the memory 825, the code 830, the transceiver 810, or any combination thereof. For example, the code 830 may include instructions executable by the processor 835 to cause the device 805 to perform various aspects of controlling a RIS using a weighting matrix as described herein, or the processor 835 and the memory 825 may be otherwise configured to perform or support such operations.

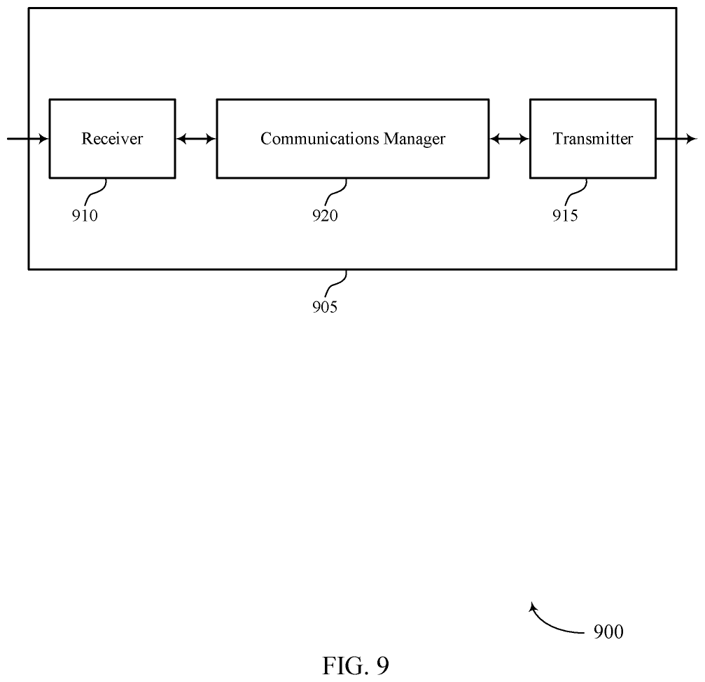

FIG. 9 shows a block diagram 900 of a device 905 that supports controlling a RIS using a weighting matrix in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to controlling a RIS using a weighting matrix). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to controlling a RIS using a weighting matrix). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of controlling a RIS using a weighting matrix as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. For example, the communications manager 920 may be configured as or otherwise support a means for receiving an indication of a set of resources allocated to the UE according to a SPS or a configured grant. The communications manager 920 may be configured as or otherwise support a means for receiving an indication of a set of multiple TCI states corresponding to a weighting matrix for a RIS, the set of multiple TCI states corresponding to a set of multiple transmission occasions in the set of resources allocated to the UE. The communications manager 920 may be configured as or otherwise support a means for communicating with a network entity over the set of resources via the RIS, where the communicating is based on cyclically applying different TCI states of the set of multiple TCI states to the set of multiple transmission occasions.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for a network entity to transmit a resource allocation and weighting matrix to a RIS controller, where the RIS controller cyclically applies the weighting matrix to reflective elements of the RIS for beamforming, which may provide for reduced processing, reduced power consumption, more efficient utilization of communication resources, or any combination thereof.

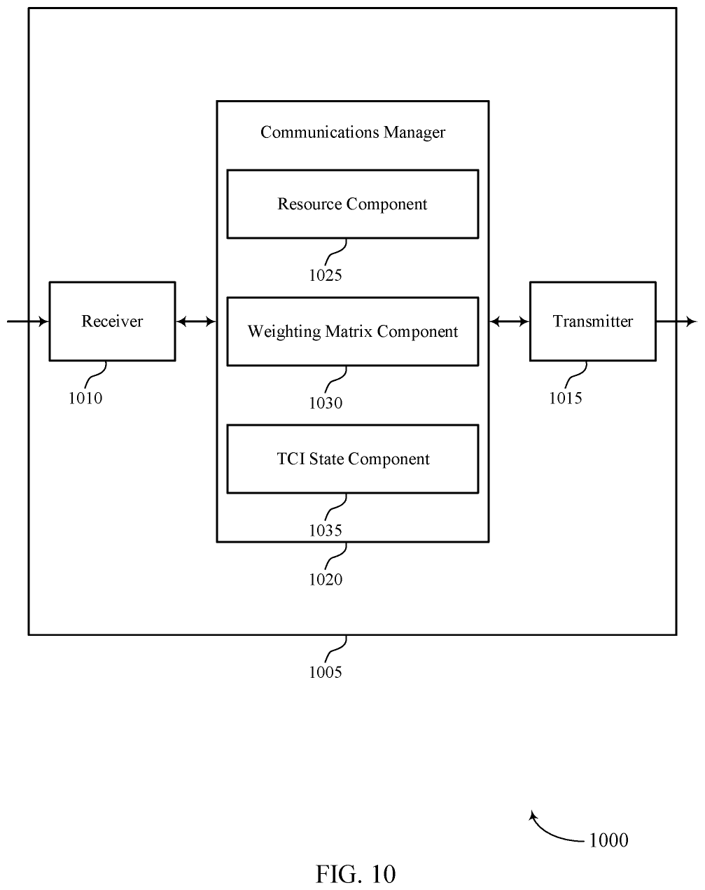

FIG. 10 shows a block diagram 1000 of a device 1005 that supports controlling a RIS using a weighting matrix in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to controlling a RIS using a weighting matrix). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to controlling a RIS using a weighting matrix). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of controlling a RIS using a weighting matrix as described herein. For example, the communications manager 1020 may include a resource component 1025, a weighting matrix component 1030, a TCI state component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. The resource component 1025 may be configured as or otherwise support a means for receiving an indication of a set of resources allocated to the UE according to a SPS or a configured grant. The weighting matrix component 1030 may be configured as or otherwise support a means for receiving an indication of a set of multiple TCI states corresponding to a weighting matrix for a RIS, the set of multiple TCI states corresponding to a set of multiple transmission occasions in the set of resources allocated to the UE. The TCI state component 1035 may be configured as or otherwise support a means for applying different TCI states of the plurality of TCI states to the plurality of transmission occasions to communicate with a network entity over the set of resources via the RIS.

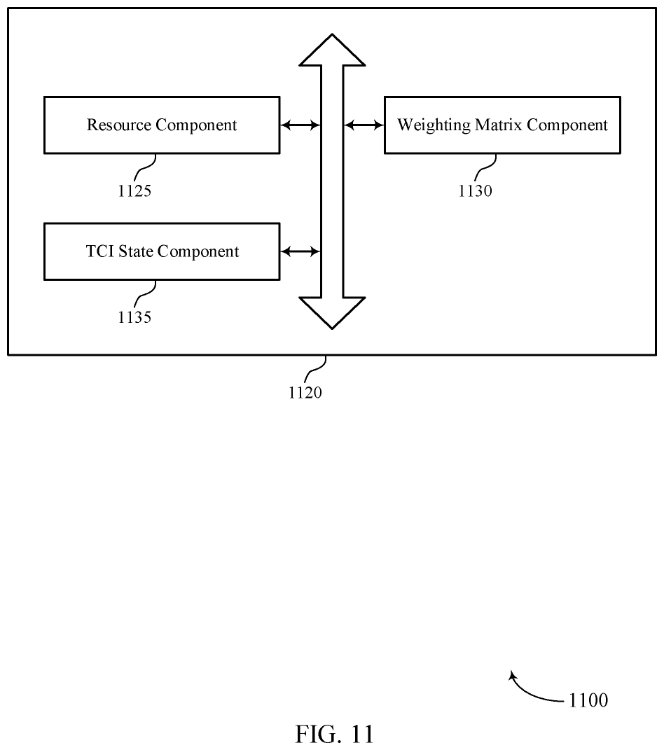

FIG. 11 shows a block diagram 1100 of a communications manager 1120 that supports controlling a RIS using a weighting matrix in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of controlling a RIS using a weighting matrix as described herein. For example, the communications manager 1120 may include a resource component 1125, a weighting matrix component 1130, a TCI state component 1135, or any combination thereof. Each of these components may communicate, directly or indirectly, with one another (e.g., via one or more buses).

The communications manager 1120 may support wireless communication at a UE in accordance with examples as disclosed herein. The resource component 1125 may be configured as or otherwise support a means for receiving an indication of a set of resources allocated to the UE according to a SPS or a configured grant. The weighting matrix component 1130 may be configured as or otherwise support a means for receiving an indication of a set of multiple TCI states corresponding to a weighting matrix for a RIS, the set of multiple TCI states corresponding to a set of multiple transmission occasions in the set of resources allocated to the UE. The TCI state component 1135 may be configured as or otherwise support a means for applying different TCI states of the plurality of TCI states to the plurality of transmission occasions to communicate with a network entity over the set of resources via the RIS.

In some examples, to support communicating with the network entity, the TCI state component 1135 may be configured as or otherwise support a means for transmitting signaling over the set of resources via the RIS.

In some examples, to support communicating with the network entity, the TCI state component 1135 may be configured as or otherwise support a means for receiving signaling over the set of resources via the RIS.

In some examples, the network entity includes another UE, and the weighting matrix component 1130 may be configured as or otherwise support a means for receiving the indication of the set of multiple TCI states corresponding to the weighting matrix in sidelink control information.

In some examples, the resource component 1125 may be configured as or otherwise support a means for receiving the indication of the set of resources allocated to the UE according to the configured grant, where radio resource control signaling or a medium access control-control element include the indication of the set of resources and the indication of the weighting matrix.

In some examples, the weighting matrix component 1130 may be configured as or otherwise support a means for receiving the indication of the set of multiple TCI states corresponding to the weighting matrix in a stage of control information common to the RIS and the UE.

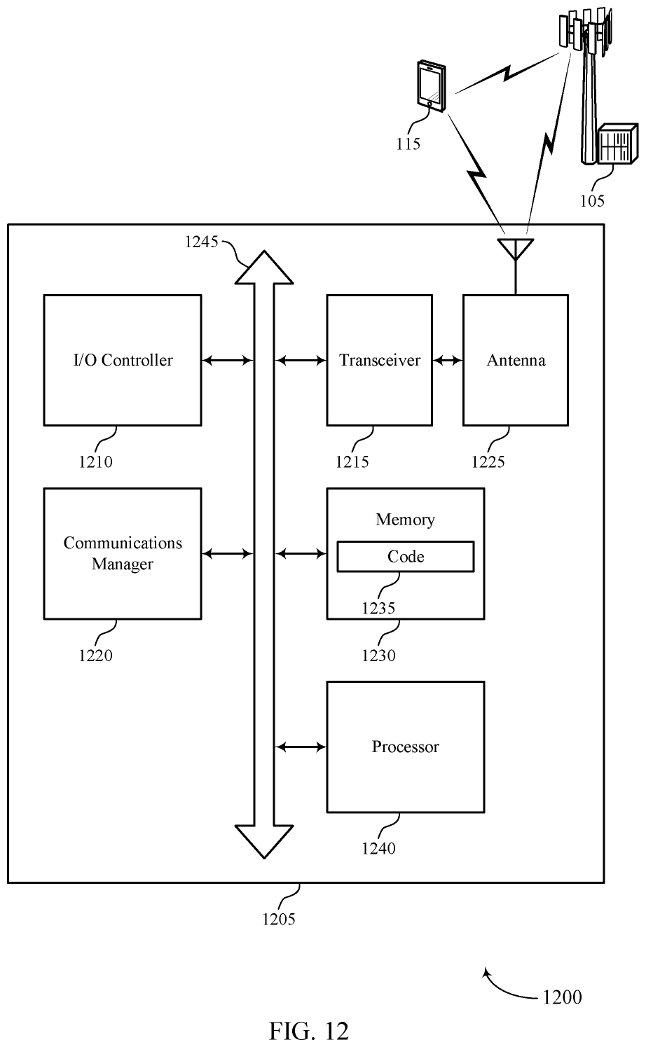

FIG. 12 shows a diagram of a system 1200 including a device 1205 that supports controlling a RIS using a weighting matrix in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, a RIS controller or RIS CU, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting controlling a RIS using a weighting matrix). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for receiving an indication of a set of resources allocated to the UE according to a SPS or a configured grant. The communications manager 1220 may be configured as or otherwise support a means for receiving an indication of a set of multiple TCI states corresponding to a weighting matrix for a RIS, the set of multiple TCI states corresponding to a set of multiple transmission occasions in the set of resources allocated to the UE. The communications manager 1220 may be configured as or otherwise support a means for applying different TCI states of the plurality of TCI states to the plurality of transmission occasions to communicate with a network entity over the set of resources via the RIS.

By including or configuring the communications manager 1220 in accordance with examples as described herein, the device 1205 may support techniques for a network entity to transmit a resource allocation and weighting matrix to a RIS controller, where the RIS controller cyclically applies the weighting matrix to reflective elements of the RIS for beamforming, which may provide for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of controlling a RIS using a weighting matrix as described herein, or the processor 1240 and the memory 1230 may be otherwise configured to perform or support such operations.

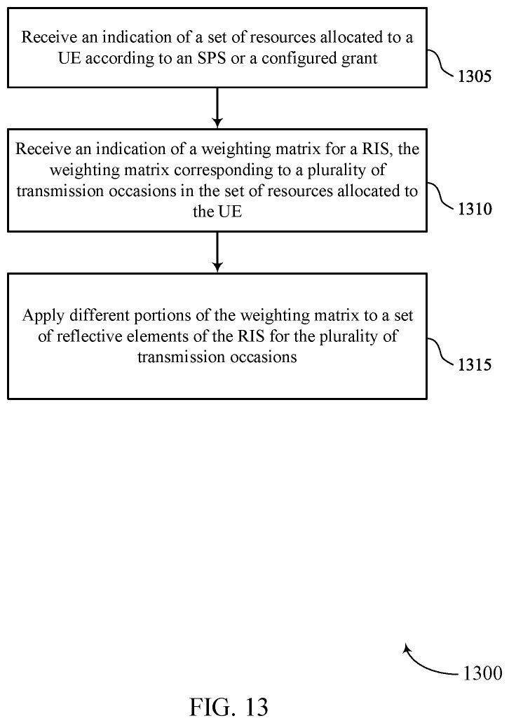

FIG. 13 shows a flowchart illustrating a method 1300 that supports controlling a RIS using a weighting matrix in accordance with one or more aspects of the present disclosure. The operations of the method 1300 may be implemented by a network entity, such as a RIS controller or RIS CU, or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include receiving an indication of a set of resources allocated to a UE according to a SPS or a configured grant. The operations of 1305 may be performed in accordance with examples as disclosed herein. In some examples, aspects of the operations of 1305 may be performed by a resource manager 725 as described with reference to FIG. 7.

At 1310, the method may include receiving an indication of a weighting matrix for a RIS, the weighting matrix corresponding to a set of multiple transmission occasions in the set of resources allocated to the UE. The operations of 1310 may be performed in accordance with examples as disclosed herein. In some examples, aspects of the operations of 1310 may be performed by a weighting matrix manager 730 as described with reference to FIG. 7.

At 1315, the method may include applying different portions of the weighting matrix to a set of reflective elements of the RIS for the set of multiple transmission occasions. The operations of 1315 may be performed in accordance with examples as disclosed herein. In some examples, aspects of the operations of 1315 may be performed by a reflective element manager 735 as described with reference to FIG. 7.

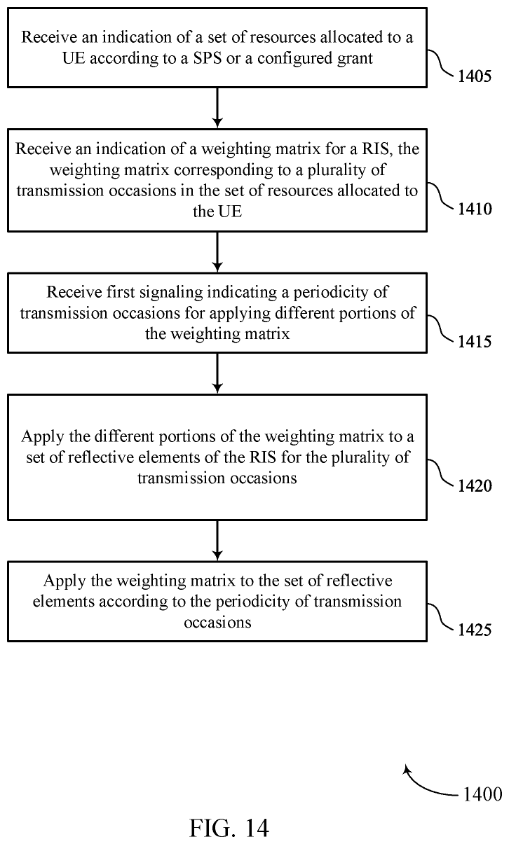

FIG. 14 shows a flowchart illustrating a method 1400 that supports controlling a RIS using a weighting matrix in accordance with one or more aspects of the present disclosure. The operations of the method 1400 may be implemented by a network entity, such as a RIS controller or RIS CU, or its components as described herein. For example, the operations of the method 1400 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1405, the method may include receiving an indication of a set of resources allocated to a UE according to a SPS or a configured grant. The operations of 1405 may be performed in accordance with examples as disclosed herein. In some examples, aspects of the operations of 1405 may be performed by a resource manager 725 as described with reference to FIG. 7.

At 1410, the method may include receiving an indication of a weighting matrix for a RIS, the weighting matrix corresponding to a set of multiple transmission occasions in the set of resources allocated to the UE. The operations of 1410 may be performed in accordance with examples as disclosed herein. In some examples, aspects of the operations of 1410 may be performed by a weighting matrix manager 730 as described with reference to FIG. 7.

At 1415, the method may include receiving first signaling indicating a periodicity of transmission occasions for applying different portions of the weighting matrix. The operations of 1415 may be performed in accordance with examples as disclosed herein. In some examples, aspects of the operations of 1415 may be performed by a weighting matrix manager 730 as described with reference to FIG. 7.

At 1420, the method may include applying the different portions of the weighting matrix to a set of reflective elements of the RIS for the set of multiple transmission occasions. The operations of 1420 may be performed in accordance with examples as disclosed herein. In some examples, aspects of the operations of 1420 may be performed by a reflective element manager 735 as described with reference to FIG. 7.

At 1425, the method may include applying the weighting matrix to the set of reflective elements according to the periodicity of transmission occasions. The operations of 1425 may be performed in accordance with examples as disclosed herein. In some examples, aspects of the operations of 1425 may be performed by a reflective element manager 735 as described with reference to FIG. 7.

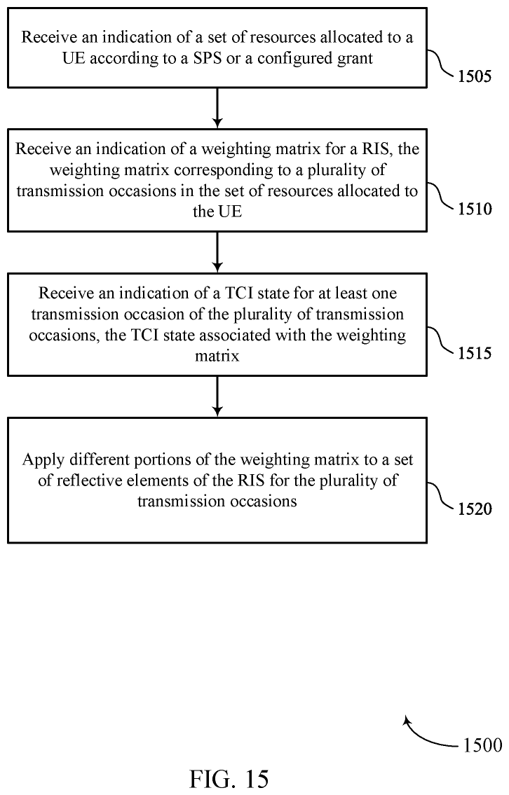

FIG. 15 shows a flowchart illustrating a method 1500 that supports controlling a RIS using a weighting matrix in accordance with one or more aspects of the present disclosure. The operations of the method 1500 may be implemented by a network entity, such as a RIS controller or RIS CU, or its components as described herein. For example, the operations of the method 1500 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1505, the method may include receiving an indication of a set of resources allocated to a UE according to a SPS or a configured grant. The operations of 1505 may be performed in accordance with examples as disclosed herein. In some examples, aspects of the operations of 1505 may be performed by a resource manager 725 as described with reference to FIG. 7.

At 1510, the method may include receiving an indication of a weighting matrix for a RIS, the weighting matrix corresponding to a set of multiple transmission occasions in the set of resources allocated to the UE. The operations of 1510 may be performed in accordance with examples as disclosed herein. In some examples, aspects of the operations of 1510 may be performed by a weighting matrix manager 730 as described with reference to FIG. 7.

At 1515, the method may include receiving an indication of a TCI state for at least one transmission occasion of the set of multiple transmission occasions, the TCI state associated with the weighting matrix. The operations of 1515 may be performed in accordance with examples as disclosed herein. In some examples, aspects of the operations of 1515 may be performed by a TCI state manager 740 as described with reference to FIG. 7.

At 1520, the method may include applying different portions of the weighting matrix to a set of reflective elements of the RIS for the set of multiple transmission occasions. The operations of 1520 may be performed in accordance with examples as disclosed herein. In some examples, aspects of the operations of 1520 may be performed by a reflective element manager 735 as described with reference to FIG. 7.

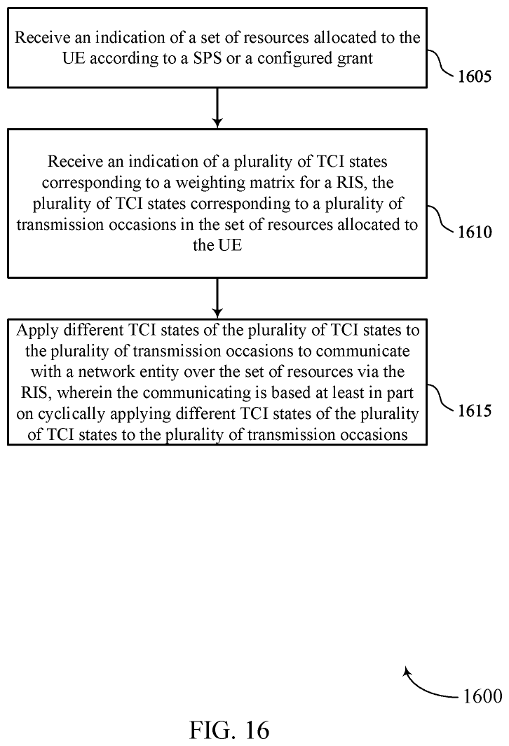

FIG. 16 shows a flowchart illustrating a method 1600 that supports controlling a RIS using a weighting matrix in accordance with one or more aspects of the present disclosure. The operations of the method 1600 may be implemented by a UE or its components as described herein. For example, the operations of the method 1600 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1605, the method may include receiving an indication of a set of resources allocated to the UE according to a SPS or a configured grant. The operations of 1605 may be performed in accordance with examples as disclosed herein. In some examples, aspects of the operations of 1605 may be performed by a resource component 1125 as described with reference to FIG. 11.

At 1610, the method may include receiving an indication of a set of multiple TCI states corresponding to a weighting matrix for a RIS, the set of multiple TCI states corresponding to a set of multiple transmission occasions in the set of resources allocated to the UE. The operations of 1610 may be performed in accordance with examples as disclosed herein. In some examples, aspects of the operations of 1610 may be performed by a weighting matrix component 1130 as described with reference to FIG. 11.

At 1615, the method may include applying different TCI states of the plurality of TCI states to the plurality of transmission occasions to communicate with a network entity over the set of resources via the RIS. The operations of 1615 may be performed in accordance with examples as disclosed herein. In some examples, aspects of the operations of 1615 may be performed by a TCI state component 1135 as described with reference to FIG. 11.

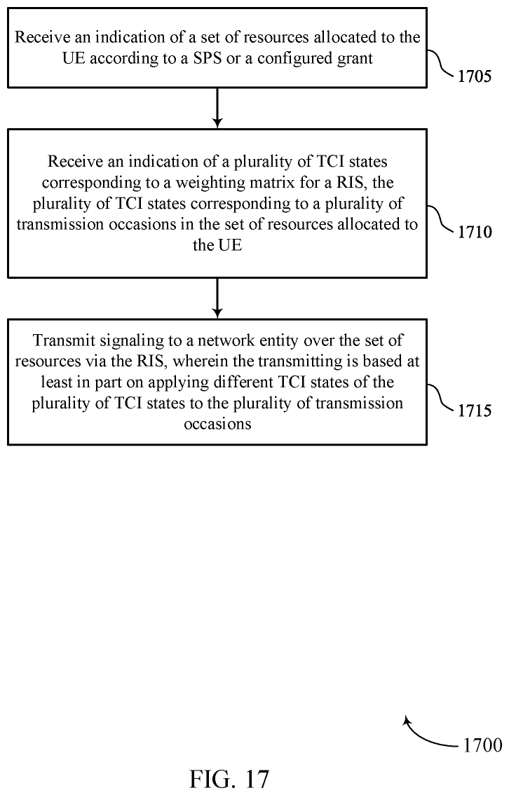

FIG. 17 shows a flowchart illustrating a method 1700 that supports controlling a RIS using a weighting matrix in accordance with one or more aspects of the present disclosure. The operations of the method 1700 may be implemented by a UE or its components as described herein. For example, the operations of the method 1700 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1705, the method may include receiving an indication of a set of resources allocated to the UE according to a SPS or a configured grant. The operations of 1705 may be performed in accordance with examples as disclosed herein. In some examples, aspects of the operations of 1705 may be performed by a resource component 1125 as described with reference to FIG. 11.

At 1710, the method may include receiving an indication of a set of multiple TCI states corresponding to a weighting matrix for a RIS, the set of multiple TCI states corresponding to a set of multiple transmission occasions in the set of resources allocated to the UE. The operations of 1710 may be performed in accordance with examples as disclosed herein. In some examples, aspects of the operations of 1710 may be performed by a weighting matrix component 1130 as described with reference to FIG. 11.

At 1715, the method may include transmitting signaling to a network entity over the set of resources via the RIS, where the transmitting is based on cyclically applying different TCI states of the set of multiple TCI states to the set of multiple transmission occasions. The operations of 1715 may be performed in accordance with examples as disclosed herein. In some examples, aspects of the operations of 1715 may be performed by a TCI state component 1135 as described with reference to FIG. 11.

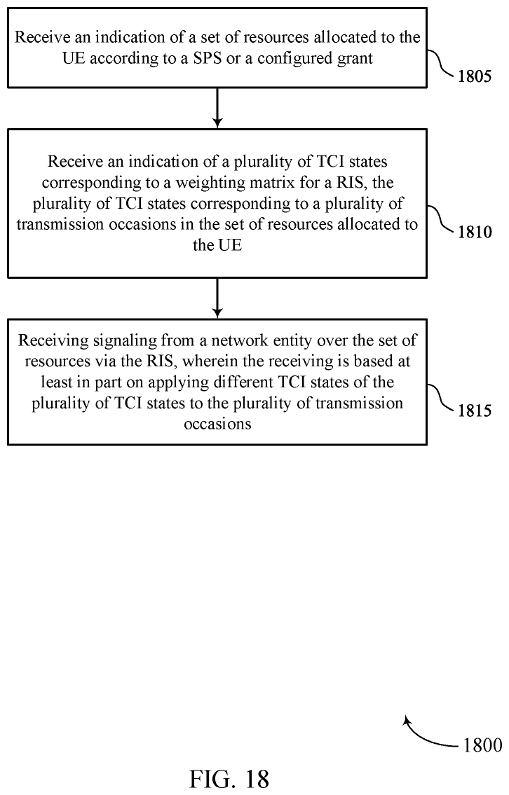

FIG. 18 shows a flowchart illustrating a method 1800 that supports controlling a RIS using a weighting matrix in accordance with one or more aspects of the present disclosure. The operations of the method 1800 may be implemented by a UE or its components as described herein. For example, the operations of the method 1800 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1805, the method may include receiving an indication of a set of resources allocated to the UE according to a SPS or a configured grant. The operations of 1805 may be performed in accordance with examples as disclosed herein. In some examples, aspects of the operations of 1805 may be performed by a resource component 1125 as described with reference to FIG. 11.

At 1810, the method may include receiving an indication of a set of multiple TCI states corresponding to a weighting matrix for a RIS, the set of multiple TCI states corresponding to a set of multiple transmission occasions in the set of resources allocated to the UE. The operations of 1810 may be performed in accordance with examples as disclosed herein. In some examples, aspects of the operations of 1810 may be performed by a weighting matrix component 1130 as described with reference to FIG. 11.

At 1815, the method may include receiving signaling from a network entity over the set of resources via the RIS, where the receiving is based on cyclically applying different TCI states of the set of multiple TCI states to the set of multiple transmission occasions. The operations of 1815 may be performed in accordance with examples as disclosed herein. In some examples, aspects of the operations of 1815 may be performed by a TCI state component 1135 as described with reference to FIG. 11.

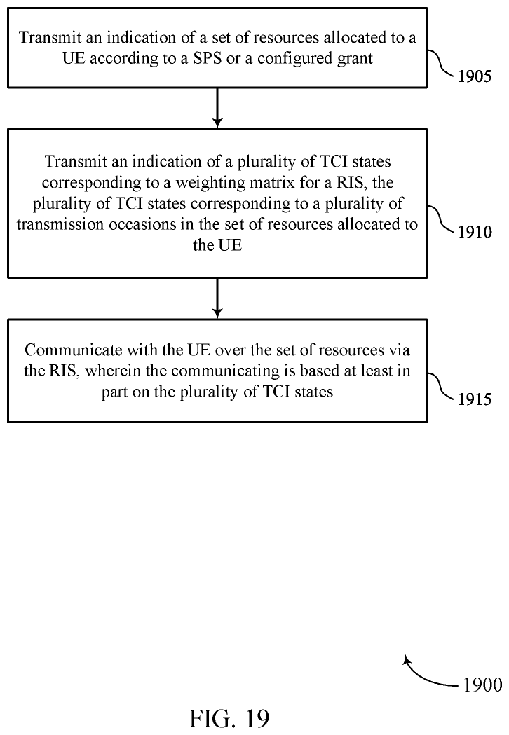

FIG. 19 shows a flowchart illustrating a method 1900 that supports controlling a RIS using a weighting matrix in accordance with one or more aspects of the present disclosure. The operations of the method 1900 may be implemented by a network entity or its components as described herein. For example, the operations of the method 1900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1905, the method may include transmitting an indication of a set of resources allocated to a UE according to a SPS or a configured grant. The operations of 1905 may be performed in accordance with examples as disclosed herein. In some examples, aspects of the operations of 1905 may be performed by a resource manager 725 as described with reference to FIG. 7.

At 1910, the method may include transmitting an indication of a set of multiple TCI states corresponding to a weighting matrix for a RIS, the set of multiple TCI states corresponding to a set of multiple transmission occasions in the set of resources allocated to the UE. The operations of 1910 may be performed in accordance with examples as disclosed herein. In some examples, aspects of the operations of 1910 may be performed by a weighting matrix manager 730 as described with reference to FIG. 7.

At 1915, the method may include communicating with the UE over the set of resources via the RIS, where the communicating is based on the set of multiple TCI states. The operations of 1915 may be performed in accordance with examples as disclosed herein. In some examples, aspects of the operations of 1915 may be performed by a TCI state manager 740 as described with reference to FIG. 7.

The following provides an overview of aspects of the present disclosure:

Aspect 1: A method for wireless communication at a network entity, comprising: receiving an indication of a set of resources allocated to a UE according to a semi-persistent scheduling or a configured grant; receiving an indication of a weighting matrix for a reconfigurable intelligent surface, the weighting matrix corresponding to a plurality of transmission occasions in the set of resources allocated to the UE; and applying different portions of the weighting matrix to a set of reflective elements of the reconfigurable intelligent surface for the plurality of transmission occasions.

Aspect 2: The method of aspect 1, wherein applying the different portions of the weighting matrix comprises: receiving first signaling indicating a periodicity of transmission occasions for applying the different portions of the weighting matrix; and applying the weighting matrix to the set of reflective elements according to the periodicity of transmission occasions.

Aspect 3: The method of aspect 2, further comprising: receiving second signaling indicating an updated periodicity of transmission occasions for applying the different portions of the weighting matrix, wherein the second signaling comprises downlink control information signaling.

Aspect 4: The method of aspect 3, wherein a size of the downlink control information signaling corresponds to a number of different portions of the weighting matrix.

Aspect 5: The method of any of aspects 1 through 4, further comprising: receiving an indication of a transmission configuration indicator (TCI) state for at least one transmission occasion of the plurality of transmission occasions, the TCI state associated with the weighting matrix.

Aspect 6: The method of any of aspects 1 through 5, further comprising: receiving a priority indicator for the set of resources; and determining a communication resolution for the plurality of transmission occasions in accordance with the priority indicator.

Aspect 7: The method of any of aspects 1 through 6, further comprising: transmitting a feedback message, wherein receiving the indication of the weighting matrix is based at least in part on transmitting the feedback message.

Aspect 8: The method of aspect 7, further comprising: apply zero value weights of the weighting matrix to the set of reflective elements of the reconfigurable intelligent surface based at least in part on transmitting a negative acknowledgement message, wherein the feedback message comprises the negative acknowledgement message and the indication of the weighting matrix comprises the zero value weights.

Aspect 9: The method of aspect 7, further comprising: apply a default transmission configuration indicator (TCI) for the plurality of transmission occasions based at least in part on transmitting a negative acknowledgement message, wherein the feedback message comprises the negative acknowledgement message.

Aspect 10: The method of aspect 9, wherein the default TCI is configured at the reconfigurable intelligent surface based at least in part on a frequency band of operation, a component carrier, a zone identifier, a position of the UE, or any combination thereof.

Aspect 11: The method of aspect 9, wherein the default TCI is a last known TCI based at least in part on a zone identifier, a position of the UE, previous communications with the UE, or any combination thereof.

Aspect 12: The method of any of aspects 1 through 11, further comprising: receiving the indication of the weighting matrix in multiple stages of control information comprising a first stage of control information common to the reconfigurable intelligent surface and the UE and a second stage of control information specific to the reconfigurable intelligent surface.

Aspect 13: The method of any of aspects 1 through 12, further comprising: receiving control information comprising the indication of the weighting matrix, wherein a size of the control information is based at least in part on a maximum number of transmission occasions in the plurality of transmission occasions.

Aspect 14: The method of any of aspects 1 through 13, further comprising: receiving an indication of one or more transmission configuration indicator (TCI) indices for the plurality of transmission occasions, wherein the applying the different portions of the weighting matrix to the set of reflective elements of the reconfigurable intelligent surface is in accordance with the one or more TCI indices.

Aspect 15: The method of any of aspects 1 through 14, further comprising: receiving the indication of the set of resources allocated to the UE according to the configured grant, wherein radio resource control signaling or a medium access control-control element comprise the indication of the set of resources and the indication of the weighting matrix.

Aspect 16: A method for wireless communication at a UE, comprising: receiving an indication of a set of resources allocated to the UE according to a semi-persistent scheduling or a configured grant; receiving an indication of a plurality of transmission configuration indicator (TCI) states corresponding to a weighting matrix for a reconfigurable intelligent surface, the plurality of TCI states corresponding to a plurality of transmission occasions in the set of resources allocated to the UE; and applying different TCI states of the plurality of TCI states to the plurality of transmission occasions to communicate with a network entity over the set of resources via the reconfigurable intelligent surface.

Aspect 17: The method of aspect 16, further comprising: transmitting signaling over the set of resources via the reconfigurable intelligent surface.

Aspect 18: The method of aspect 16, further comprising: receiving signaling over the set of resources via the reconfigurable intelligent surface.

Aspect 19: The method of any of aspects 16 through 18, wherein the network entity comprises another UE, the method further comprising: receiving the indication of the plurality of TCI states corresponding to the weighting matrix in sidelink control information.

Aspect 20: The method of any of aspects 16 through 19, further comprising: receiving the indication of the set of resources allocated to the UE according to the configured grant, wherein radio resource control signaling or a medium access control-control element comprise the indication of the set of resources and the indication of the weighting matrix.

Aspect 21: The method of any of aspects 16 through 20, further comprising: receiving the indication of the plurality of TCI states corresponding to the weighting matrix in a stage of control information common to the reconfigurable intelligent surface and the UE.

Aspect 22: A method for wireless communication at a network entity, comprising: transmitting an indication of a set of resources allocated to a UE according to a semi-persistent scheduling or a configured grant; transmitting an indication of a plurality of transmission configuration indicator (TCI) states corresponding to a weighting matrix for a reconfigurable intelligent surface, the plurality of TCI states corresponding to a plurality of transmission occasions in the set of resources allocated to the UE; and communicating with the UE over the set of resources via the reconfigurable intelligent surface, wherein the communicating is based at least in part on the plurality of TCI states.

Aspect 23: The method of aspect 22, further comprising: transmitting first signaling indicating a periodicity of transmission occasions for applying one or more different portions of the weighting matrix to a set of reflective elements of the reconfigurable intelligent surface for the plurality of transmission occasions.

Aspect 24: The method of aspect 23, further comprising: transmitting second signaling indicating an updated periodicity of transmission occasions for applying the different portions of the weighting matrix, wherein the second signaling comprises downlink control information signaling.

Aspect 25: The method of aspect 24, wherein a size of the downlink control information signaling corresponds to a number of different portions of the weighting matrix.

Aspect 26: The method of any of aspects 22 through 25, further comprising: transmitting a priority indicator for the set of resources.

Aspect 27: The method of any of aspects 22 through 26, further comprising: receiving a feedback message, wherein transmitting the indication of the plurality of TCI states corresponding to the weighting matrix is based at least in part on receiving the feedback message.

Aspect 28: The method of aspect 27, wherein the weighting matrix comprises zero value weights based at least in part on the feedback message being a negative acknowledgement message.

Aspect 29: The method of any of aspects 22 through 28, further comprising: transmitting the indication of the plurality of TCI states corresponding to the weighting matrix in multiple stages of control information comprising a first stage of control information common to the reconfigurable intelligent surface and the UE and a second stage of control information specific to the reconfigurable intelligent surface.

Aspect 30: The method of any of aspects 22 through 29, further comprising: transmitting control information comprising an indication of the weighting matrix, wherein a size of the control information is based at least in part on a maximum number of transmission occasions in the plurality of transmission occasions.

Aspect 31: The method of any of aspects 22 through 30, further comprising: transmitting the indication of the set of resources allocated to the UE according to the configured grant, wherein radio resource control signaling or a medium access control-control element comprise the indication of the set of resources and the indication of the weighting matrix.

Aspect 32: The method of any of aspects 22 through 31, wherein the communicating with the UE further comprises: transmitting signaling over the set of resources via the reconfigurable intelligent surface.

Aspect 33: The method of any of aspects 22 through 31, wherein the communicating with the UE further comprises: receiving signaling over the set of resources via the reconfigurable intelligent surface.

Aspect 34: An apparatus for wireless communication at a network entity, comprising a processor; memory coupled with the processor; and instructions stored in the memory and executable by the processor to cause the network entity to perform a method of any of aspects 1 through 15.

Aspect 35: An apparatus for wireless communication at a network entity, comprising at least one means for performing a method of any of aspects 1 through 15.

Aspect 36: A non-transitory computer-readable medium storing code for wireless communication at a network entity, the code comprising instructions executable by a processor to perform a method of any of aspects 1 through 15.

Aspect 37: An apparatus for wireless communication at a UE, comprising a processor; memory coupled with the processor; and instructions stored in the memory and executable by the processor to cause the UE to perform a method of any of aspects 16 through 21.

Aspect 38: An apparatus for wireless communication at a UE, comprising at least one means for performing a method of any of aspects 16 through 21.

Aspect 39: A non-transitory computer-readable medium storing code for wireless communication at a UE, the code comprising instructions executable by a processor to perform a method of any of aspects 16 through 21.

Aspect 40: An apparatus for wireless communication at a network entity, comprising a processor; memory coupled with the processor; and instructions stored in the memory and executable by the processor to cause the network entity to perform a method of any of aspects 22 through 33.

Aspect 41: An apparatus for wireless communication at a network entity, comprising at least one means for performing a method of any of aspects 22 through 33.

Aspect 42: A non-transitory computer-readable medium storing code for wireless communication at a network entity, the code comprising instructions executable by a processor to perform a method of any of aspects 22 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a network entity, comprising:
at least one processor; and
memory coupled with the at least one processor, the memory storing instructions executable by the at least one processor to cause the network entity to:
receive an indication of a set of resources allocated to a user equipment (UE) according to a semi-persistent scheduling or a configured grant;
receive an indication of a weighting matrix for a reconfigurable intelligent surface, the weighting matrix corresponding to a plurality of transmission occasions in the set of resources allocated to the UE; and
apply different portions of the weighting matrix to a set of reflective elements of the reconfigurable intelligent surface for the plurality of transmission occasions.

2. The apparatus of claim 1, wherein the instructions to apply the different portions of the weighting matrix are executable by the at least one processor to cause the network entity to:
receive first signaling indicating a periodicity of transmission occasions for applying the different portions of the weighting matrix; and
apply the weighting matrix to the set of reflective elements according to the periodicity of transmission occasions.

3. The apparatus of claim 2, wherein the instructions are further executable by the at least one processor to cause the network entity to:
receive second signaling indicating an updated periodicity of transmission occasions for applying the different portions of the weighting matrix, wherein the second signaling comprises downlink control information signaling.

4. The apparatus of claim 3, wherein a size of the downlink control information signaling corresponds to a number of different portions of the weighting matrix.

5. The apparatus of claim 1, wherein the instructions are further executable by the at least one processor to cause the network entity to:
receive an indication of a transmission configuration indicator (TCI) state for at least one transmission occasion of the plurality of transmission occasions, the TCI state associated with the weighting matrix.

6. The apparatus of claim 1, wherein the instructions are further executable by the at least one processor to cause the network entity to:
receive a priority indicator for the set of resources; and
determine a communication resolution for the plurality of transmission occasions in accordance with the priority indicator.

7. The apparatus of claim 1, wherein the instructions are further executable by the at least one processor to cause the network entity to:
transmit a feedback message, wherein receiving the indication of the weighting matrix is based at least in part on transmitting the feedback message.

8. The apparatus of claim 7, wherein the instructions are further executable by the at least one processor to cause the network entity to:
apply zero value weights of the weighting matrix to the set of reflective elements of the reconfigurable intelligent surface based at least in part on transmitting a negative acknowledgement message, wherein the feedback message comprises the negative acknowledgement message and the indication of the weighting matrix comprises the zero value weights.

9. The apparatus of claim 7, wherein the instructions are further executable by the at least one processor to cause the network entity to:
apply a default transmission configuration indicator (TCI) for the plurality of transmission occasions based at least in part on transmitting a negative acknowledgement message, wherein the feedback message comprises the negative acknowledgement message.

10. The apparatus of claim 9, wherein the default TCI is configured at the reconfigurable intelligent surface based at least in part on a frequency band of operation, a component carrier, a zone identifier, a position of the UE, or any combination thereof.

11. The apparatus of claim 9, wherein the default TCI is a last known TCI based at least in part on a zone identifier, a position of the UE, previous communications with the UE, or any combination thereof.

12. The apparatus of claim 1, wherein the instructions are further executable by the at least one processor to cause the network entity to:
receive the indication of the weighting matrix in multiple stages of control information comprising a first stage of control information common to the reconfigurable intelligent surface and the UE and a second stage of control information specific to the reconfigurable intelligent surface.

13. The apparatus of claim 1, wherein the instructions are further executable by the at least one processor to cause the network entity to:
receive control information comprising the indication of the weighting matrix, wherein a size of the control information is based at least in part on a maximum number of transmission occasions in the plurality of transmission occasions.

14. The apparatus of claim 1, wherein the instructions are further executable by the at least one processor to cause the network entity to:
receive an indication of one or more transmission configuration indicator (TCI) indices for the plurality of transmission occasions, wherein the applying the different portions of the weighting matrix to the set of reflective elements of the reconfigurable intelligent surface is in accordance with the one or more TCI indices.

15. The apparatus of claim 1, wherein the instructions are further executable by the at least one processor to cause the network entity to:
receive the indication of the set of resources allocated to the UE according to the configured grant, wherein radio resource control signaling or a medium access control-control element comprise the indication of the set of resources and the indication of the weighting matrix.

16. An apparatus for wireless communication at a user equipment (UE), comprising:
at least one processor; and
memory coupled with the at least one processor the memory storing instructions executable by the at least one processor to cause the UE to:
receive an indication of a set of resources allocated to the UE according to a semi-persistent scheduling or a configured grant;
receive an indication of a plurality of transmission configuration indicator (TCI) states corresponding to a weighting matrix for a reconfigurable intelligent surface, the plurality of TCI states corresponding to a plurality of transmission occasions in the set of resources allocated to the UE; and
apply different TCI states of the plurality of TCI states to the plurality of transmission occasions to communicate with a network entity over the set of resources via the reconfigurable intelligent surface.

17. The apparatus of claim 16, wherein the instructions are further executable by the at least one processor to cause the UE to:
transmit signaling over the set of resources via the reconfigurable intelligent surface.

18. The apparatus of claim 16, wherein the instructions are further executable by the at least one processor to cause the UE to:
receive signaling over the set of resources via the reconfigurable intelligent surface.

19. The apparatus of claim 16, wherein the network entity comprises another UE, and the instructions are further executable by the at least one processor to cause the UE to:
receive the indication of the plurality of TCI states corresponding to the weighting matrix in sidelink control information.

20. The apparatus of claim 16, wherein the instructions are further executable by the at least one processor to cause the UE to:
receive the indication of the set of resources allocated to the UE according to the configured grant, wherein radio resource control signaling or a medium access control-control element comprise the indication of the set of resources and the indication of the weighting matrix.

21. The apparatus of claim 16, wherein the instructions are further executable by the at least one processor to cause the UE to:
receive the indication of the plurality of TCI states corresponding to the weighting matrix in a stage of control information common to the reconfigurable intelligent surface and the UE.

22. An apparatus for wireless communication at a network entity, comprising:
at least one processor; and
memory coupled with the at least one processor the memory storing instructions executable by the at least one processor to cause the network entity to:
transmit an indication of a set of resources allocated to a user equipment (UE) according to a semi-persistent scheduling or a configured grant;
transmit an indication of a plurality of transmission configuration indicator (TCI) states corresponding to a weighting matrix for a reconfigurable intelligent surface, the plurality of TCI states corresponding to a plurality of transmission occasions in the set of resources allocated to the UE; and
communicate with the UE over the set of resources via the reconfigurable intelligent surface, wherein the communicating is based at least in part on the plurality of TCI states.

23. The apparatus of claim 22, wherein the instructions are further executable by the at least one processor to cause the network entity to:
transmit first signaling indicating a periodicity of transmission occasions for applying one or more different portions of the weighting matrix to a set of reflective elements of the reconfigurable intelligent surface for the plurality of transmission occasions.

24. The apparatus of claim 23, wherein the instructions are further executable by the at least one processor to cause the network entity to:
transmit second signaling indicating an updated periodicity of transmission occasions for applying the different portions of the weighting matrix, wherein the second signaling comprises downlink control information signaling.

25. The apparatus of claim 22, wherein the instructions are further executable by the at least one processor to cause the network entity to:
transmit a priority indicator for the set of resources.

26. The apparatus of claim 22, wherein the instructions are further executable by the at least one processor to cause the network entity to:
receive a feedback message, wherein transmitting the indication of the plurality of TCI states corresponding to the weighting matrix is based at least in part on receiving the feedback message.

27. The apparatus of claim 22, wherein the instructions are further executable by the at least one processor to cause the network entity to:
transmit the indication of the plurality of TCI states corresponding to the weighting matrix in multiple stages of control information comprising a first stage of control information common to the reconfigurable intelligent surface and the UE and a second stage of control information specific to the reconfigurable intelligent surface.

28. The apparatus of claim 22, wherein the instructions are further executable by the at least one processor to cause the network entity to:
transmit control information comprising an indication of the weighting matrix, wherein a size of the control information is based at least in part on a maximum number of transmission occasions in the plurality of transmission occasions.

29. The apparatus of claim 22, wherein the instructions are further executable by the at least one processor to cause the network entity to:
transmit the indication of the set of resources allocated to the UE according to the configured grant, wherein radio resource control signaling or a medium access control-control element comprise the indication of the set of resources and the indication of the weighting matrix.

30. A method for wireless communication at a network entity, comprising:
receiving an indication of a set of resources allocated to a user equipment (UE) according to a semi-persistent scheduling or a configured grant;
receiving an indication of a weighting matrix for a reconfigurable intelligent surface, the weighting matrix corresponding to a plurality of transmission occasions in the set of resources allocated to the UE; and
applying different portions of the weighting matrix to a set of reflective elements of the reconfigurable intelligent surface for the plurality of transmission occasions.
